(19) United States
(12) Patent Application Publication
(10) Pub. No.: US 2026/0342476 A1
(43) Pub. Date: Oct. 29, 2026

(54) INFORMATION HANDLING METHOD AND HANDLING APPARATUS, COMMUNICATION DEVICE, AND READABLE STORAGE MEDIUM

(71) Applicant: VIVO MOBILE COMMUNICATION CO., LTD., Dongguan (CN)

(72) Inventor: Xiaowan KE, Dongguan (CN)

(73) Assignee: VIVO MOBILE COMMUNICATION CO., LTD., Dongguan (CN)

(21) Appl. No.: 19/662,480

(22) Filed: Apr. 29, 2026

Related U.S. Application Data
(63) Continuation of application No. PCT/CN2024/126986, filed on Oct. 24, 2024.

(30) Foreign Application Priority Data
Oct. 31, 2023 (CN) 202311440117.7

(51) Int. Cl. H04L 1/00; H04L 69/22

(52) U.S. Cl. CPC H04L 1/0052; H04L 69/22

(57) ABSTRACT

Provided are an information handling method and handling apparatus, a communication device, and a readable storage medium. The first communication device obtains at least one of the first information and the first indication information. Based on at least one of the first information and the first indication information, the first communication device can determine that the first data packet set succeeds or fails, or discard the data packet in the first data packet set.

### CROSS-REFERENCE TO RELATED APPLICATIONS

This application is a continuation of International Patent Application No. PCT/CN 2024/126986, filed on Oct. 24, 2024, which claims priority to Chinese Patent Application No. 202311440117.7, filed in China on Oct. 31, 2023, both of which are incorporated herein by reference in their entireties.

### TECHNICAL FIELD

This application pertains to the field of wireless communications technologies, and specifically relates to an information handling method and handling apparatus, a communication device, and a readable storage medium.

### BACKGROUND

In data handling, data is handled not at a granularity of a data packet, but at a granularity of a data packet set (such as a Protocol Data Unit (PDU) set). One data packet set may include one or more data packets. During data transmission, in one data packet set, one part of data may be successfully transmitted while the other part of data may fail to be transmitted. In some scenarios, when some data packets in a PDU set are lost, the PDU set can still be used. For example, due to use of technologies such as Forward Error Correction (FEC), a data packet set with some lost data can still be decoded and used.

### SUMMARY

Embodiments of this application provide an information handling method and handling apparatus, a communication device, and a readable storage medium.

According to a first aspect, an information handling method is provided. The method includes:
obtaining, by a first communication device, at least one of first information and first indication information; and
performing, by the first communication device, a first operation according to at least one of the first information and the first indication information, where
the first information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set, where
the first operation includes at least one of the following:
determining that a first data packet set succeeds or fails;
discarding a data packet in the first data packet set; and
handling data with the data packet set as a whole, where
the first indication information is used to indicate at least one of the following: performing packet discarding according to the first information; discarding a data packet in a failed data packet set; and discarding the data packet in the data packet set.

According to a second aspect, an information handling method is provided. The method includes:
obtaining, by a second communication device, at least one of second information, third information, and first indication information; and
performing, by the second communication device, a second operation according to at least one of the second information, the third information, and the first indication information, where
the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set, where
the second operation includes at least one of the following:
determining that a first data packet set succeeds or fails;
discarding a data packet in the first data packet set;
sending at least one of first information and the first indication information to a first communication device; and
handling data with the data packet set as a whole, where
the first information is used to indicate at least one of the following:
the handling information with the data packet set as a whole;
the criterion for using the data packet set, or the criterion for being incapable of using the data packet set;
the criterion for the data packet set to succeed, or the criterion for the data packet set to fail; and
the criterion for discarding the data packet in the data packet set, where
the first indication information is used to indicate at least one of the following: performing packet discarding according to the first information; discarding a data packet in a failed data packet set; and discarding the data packet in the data packet set; and
the third information is used to indicate one of the following information: inconsistent handling of all data packet sets with the data packet set as a whole, and consistent handling of all data packet sets with the data packet set as a whole.

According to a third aspect, an information handling method is provided. The method includes:
performing, by a third communication device, a third operation, where the third operation includes at least one of the following:
detecting second information of a first data packet set;
setting a packet header of a first data packet to include the second information of the first data packet set, where the first data packet is a data packet in the first data packet set; and
sending the first data packet set, where a packet header of the first data packet set includes the second information, and
the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set.

According to a fourth aspect, an information handling method is provided. The method includes:
performing, by a fourth communication device, a fourth operation, where the fourth operation includes at least one of the following:
sending at least one of first information and first indication information to a first communication device;
sending at least one of second information and the first indication information to a second communication device;
sending fourth information to a third communication device; and
obtaining third information, where the third information is used to indicate one of the following information: inconsistent handling of all data packet sets with the data packet set as a whole, and consistent handling of all data packet sets with the data packet set as a whole, where
the first information or the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set, where
the first indication information is used to indicate at least one of the following: performing packet discarding according to the first information; discarding a data packet in a failed data packet set; and discarding the data packet in the data packet set, where
the fourth information includes at least one of the following:
protocol description information, where the protocol description information is used for at least one of the following: describing a protocol used for a service flow, and indicating that the protocol described by the protocol description information can provide information used to determine second information of a first data packet set; and
second indication information or third indication information, where
the second indication information is used to indicate at least one of the following:
detecting second information of the data packet set; and
setting a packet header of a data packet to include the second information of the data packet set, where the data packet is a data packet in the data packet set, where
the third indication information is used to indicate at least one of the following:
detecting data packet set information corresponding to the data packet; and
setting the packet header of the data packet to include the data packet set information corresponding to the data packet.

According to a fifth aspect, an information handling apparatus is provided, including:
a first obtaining module, configured to obtain at least one of first information and first indication information; and
a first operation module, configured to perform a first operation according to at least one of the first information and the first indication information, where
the first information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set, where
the first operation includes at least one of the following:
determining that a first data packet set succeeds or fails;
discarding a data packet in the first data packet set; and
handling data with the data packet set as a whole, where
the first indication information is used to indicate at least one of the following:
performing packet discarding according to the first information; discarding a data packet in a failed data packet set; and discarding the data packet in the data packet set.

According to a sixth aspect, an information handling apparatus is provided, including:
a second obtaining module, configured to obtain at least one of second information, third information, and first indication information; and
a second operation module, configured to perform a second operation according to at least one of the second information, the third information, and the first indication information, where
the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set, where
the second operation includes at least one of the following:
determining that a first data packet set succeeds or fails;
discarding a data packet in the first data packet set; and
sending at least one of first information and the first indication information to a first communication device; and
handling data with the data packet set as a whole, where
the first information is used to indicate at least one of the following:
the handling information with the data packet set as a whole;
the criterion for using the data packet set, or the criterion for being incapable of using the data packet set;
the criterion for the data packet set to succeed, or the criterion for the data packet set to fail; and
the criterion for discarding the data packet in the data packet set, where
the first indication information is used to indicate at least one of the following: performing packet discarding according to the first information; discarding a data packet in a failed data packet set; and discarding the data packet in the data packet set; and
the third information is used to indicate one of the following information: inconsistent handling of all data packet sets with the data packet set as a whole, and consistent handling of all data packet sets with the data packet set as a whole.

According to a seventh aspect, an information handling apparatus is provided, including:
a third operation module, configured to perform a third operation, where the third operation includes at least one of the following:
detecting second information of a first data packet set;
setting a packet header of a first data packet to include the second information of the first data packet set, where the first data packet is a data packet in the first data packet set; and
sending the first data packet set, where a packet header of the first data packet set includes the second information, and
the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set.

According to an eighth aspect, an information handling apparatus is provided, including:
a fourth operation module, configured to perform a fourth operation, where the fourth operation includes at least one of the following:
sending at least one of first information and first indication information to a first communication device;
sending at least one of second information and the first indication information to a second communication device;
sending fourth information to a third communication device; and
obtaining third information, where the third information is used to indicate one of the following information: inconsistent handling of all data packet sets with the data packet set as a whole, and consistent handling of all data packet sets with the data packet set as a whole, where
the first information or the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set, where
the first indication information is used to indicate at least one of the following: performing packet discarding according to the first information; discarding a data packet in a failed data packet set; and discarding the data packet in the data packet set, where
the fourth information includes at least one of the following:
protocol description information, where the protocol description information is used for at least one of the following: describing a protocol used for a service flow, and indicating that the protocol described by the protocol description information can provide information used to determine second information of a first data packet set; and
second indication information or third indication information, where
the second indication information is used to indicate at least one of the following:
detecting second information of the data packet set; and
setting a packet header of a data packet to include the second information of the data packet set, where the data packet is a data packet in the data packet set, where
the third indication information is used to indicate at least one of the following:
detecting data packet set information corresponding to the data packet; and
setting the packet header of the data packet to include the data packet set information corresponding to the data packet.

According to a ninth aspect, a communication device is provided. The communication device includes a processor and a memory. The memory stores a program or instructions executable on the processor, and the program or the instructions are executed by the processor to implement the steps of the method according to the first aspect, the second aspect, the third aspect, or the fourth aspect.

According to a tenth aspect, a communication device is provided, including a processor and a communication interface. The processor is configured to obtain at least one of first information and first indication information; and perform a first operation according to at least one of the first information and the first indication information, where
the first information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set, where
the first operation includes at least one of the following:
determining that a first data packet set succeeds or fails;
discarding a data packet in the first data packet set; and
handling data with the data packet set as a whole, where
the first indication information is used to indicate at least one of the following: performing packet discarding according to the first information; discarding a data packet in a failed data packet set; and discarding the data packet in the data packet set.

According to an eleventh aspect, a communication device is provided, including a processor and a communication interface. The processor is configured to obtain at least one of second information, third information, and first indication information; and perform a second operation according to at least one of the second information, the third information, and the first indication information, where
the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set, where
the second operation includes at least one of the following:
determining that a first data packet set succeeds or fails;
discarding a data packet in the first data packet set; and
sending at least one of first information and the first indication information to a first communication device; and
handling data with the data packet set as a whole, where
the first information is used to indicate at least one of the following:
the handling information with the data packet set as a whole;
the criterion for using the data packet set, or the criterion for being incapable of using the data packet set;
the criterion for the data packet set to succeed, or the criterion for the data packet set to fail; and
the criterion for discarding the data packet in the data packet set, where
the first indication information is used to indicate at least one of the following: performing packet discarding according to the first information; discarding a data packet in a failed data packet set; and discarding the data packet in the data packet set; and
the third information is used to indicate one of the following information: inconsistent handling of all data packet sets with the data packet set as a whole, and consistent handling of all data packet sets with the data packet set as a whole.

According to a twelfth aspect, a communication device is provided, including a processor and a communication interface. The processor is configured to perform a third operation, where the third operation includes at least one of the following:
detecting second information of a first data packet set;
setting a packet header of a first data packet to include the second information of the first data packet set, where the first data packet is a data packet in the first data packet set; and
sending the first data packet set, where a packet header of the first data packet set includes the second information, and
the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set.

According to a thirteenth aspect, a communication device is provided, including a processor and a communication interface. The processor is configured to perform a fourth operation, where the fourth operation includes at least one of the following:
sending at least one of first information and first indication information to a first communication device;
sending at least one of second information and the first indication information to a second communication device;
sending fourth information to a third communication device; and
obtaining third information, where the third information is used to indicate one of the following information: inconsistent handling of all data packet sets with the data packet set as a whole, and consistent handling of all data packet sets with the data packet set as a whole, where
the first information or the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set, where
the first indication information is used to indicate at least one of the following: performing packet discarding according to the first information; discarding a data packet in a failed data packet set; and discarding the data packet in the data packet set, where
the fourth information includes at least one of the following:
protocol description information, where the protocol description information is used for at least one of the following: describing a protocol used for a service flow, and indicating that the protocol described by the protocol description information can provide information used to determine second information of a first data packet set; and
second indication information or third indication information, where
the second indication information is used to indicate at least one of the following:
detecting second information of the data packet set; and
setting a packet header of a data packet to include the second information of the data packet set, where the data packet is a data packet in the data packet set, where
the third indication information is used to indicate at least one of the following:
detecting data packet set information corresponding to the data packet; and
setting the packet header of the data packet to include the data packet set information corresponding to the data packet.

According to a fourteenth aspect, a readable storage medium is provided. The readable storage medium stores a program or instructions, and the program or the instructions are executed by a processor to implement the steps of the method according to the first aspect, the second aspect, the third aspect, or the fourth aspect.

According to a fifteenth aspect, a wireless communication system is provided, including a first communication device, a second communication device, and a third communication device. The first communication device may be configured to perform the steps of the method according to the first aspect, the second communication device may be configured to perform the steps of the method according to the second aspect, and the third communication device may be configured to perform the steps of the method according to the third aspect.

According to a sixteenth aspect, a wireless communication system is provided, including a first communication device, a second communication device, a third communication device, and a fourth communication device. The first communication device may be configured to perform the steps of the method according to the first aspect, the second communication device may be configured to perform the steps of the method according to the second aspect, the third communication device may be configured to perform the steps of the method according to the third aspect, and the fourth communication device may be configured to perform the steps of the method according to the fourth aspect.

According to a seventeenth aspect, a chip is provided. The chip includes a processor and a communication interface. The communication interface is coupled to the processor. The processor is configured to run a program or instructions to implement the method according to the first aspect, the second aspect, the third aspect, or the fourth aspect.

According to an eighteenth aspect, a computer program/program product is provided. The computer program/program product is stored in a storage medium, and the program/program product is executed by at least one processor to implement the steps of the method according to the first aspect, the second aspect, the third aspect, or the fourth aspect.

### BRIEF DESCRIPTION OF DRAWINGS

FIG. 1 is a block diagram of a wireless communication system to which an embodiment of this application is applicable;

FIG. 2 is a schematic flowchart 1 of an information handling method according to an embodiment of this application;

FIG. 3 is a schematic flowchart 2 of an information handling method according to an embodiment of this application;

FIG. 4 is a schematic flowchart 3 of an information handling method according to an embodiment of this application;

FIG. 5 is a schematic flowchart 4 of an information handling method according to an embodiment of this application;

FIG. 6 is a schematic diagram 1 of interaction of an information handling method according to Embodiment 1 of this application;

FIG. 7 is a schematic diagram 2 of interaction of an information handling method according to Embodiment 2 of this application;

FIG. 8 is a schematic diagram 3 of interaction of an information handling method according to Embodiment 3 of this application;

FIG. 9 is a schematic diagram 4 of interaction of an information handling method according to Embodiment 4 of this application;

FIG. 10 is a schematic diagram 1 of a structure of an information handling apparatus according to an embodiment of this application;

FIG. 11 is a schematic diagram 2 of a structure of an information handling apparatus according to an embodiment of this application;

FIG. 12 is a schematic diagram 3 of a structure of an information handling apparatus according to an embodiment of this application;

FIG. 13 is a schematic diagram 4 of a structure of an information handling apparatus according to an embodiment of this application;

FIG. 14 is a schematic diagram 1 of a structure of a communication device according to an embodiment of this application;

FIG. 15 is a schematic diagram 1 of a hardware structure of a network side device according to an embodiment of this application; and

FIG. 16 is a schematic diagram 2 of a hardware structure of a network side device according to an embodiment of this application.

### DESCRIPTION OF EMBODIMENTS

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in this application are used to distinguish between similar objects instead of describing a specified order or sequence. It should be understood that terms used in this way are interchangeable under appropriate circumstances, so that the embodiments of this application can be implemented in an order other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions, that is, a solution 1: including A and not including B; a solution 2: including B and not including A; and a solution 3: including both A and B. The character “/” generally represents an “or” relationship between associated objects.

The term “indication” in this application may be either a direct indication (or an explicit indication) or an indirect indication (or an implicit indication). The direct indication may be understood as follows: A sender explicitly notifies, in a sent indication, a receiver of specific information, an operation that needs to be performed, a requested result, or other content. The indirect indication may be understood as: The receiver determines corresponding information based on the indication sent by the sender, or performs determining based on the indication sent by the sender, and determines, based on a determining result, the operation that needs to be performed, the requested result, or the like.

It should be noted that a technology described in the embodiments of this application is not limited to a Long Term Evolution (LTE)/LTE-Advanced (LTE-A) system, and may be further applied to another wireless communication system, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-Carrier Frequency-Division Multiple Access (SC-FDMA) system, or another system. The terms “system” and “network” are often used interchangeably in the embodiments of this application. The technology described may be used for the systems and radio technologies described above, as well as other systems and radio technologies. The following describes a New Radio (NR) system for illustrative purposes, and NR terms are used in most of the following descriptions. However, these technologies are also applicable to systems such as a 6th generation (6G) communication system other than the NR system.

A data packet set (such as a PDU set) is a set of one or more data packets (such as PDUs).

In a scenario, a PDU set is considered successfully transmitted only in a case that all data packets in the PDU set are successfully transmitted. That is, a terminal may discard a remaining data packet as long as one data packet fails. For example, in a case that an uplink PDU set includes 10 data packets, first four data packets succeed, and a 5th data packet fails, remaining five data packets may be discarded.

A success criterion for the PDU set is that the PDU set is considered successful only in a case that all the data packets in the PDU set are successfully transmitted or successfully received.

However, in some other scenarios, there may be some cases that a PDU set can still be used in a case that some data packets are lost. For example, due to use of technologies such as FEC, for some PDU sets, in a case that X % of data packets are obtained, the PDU set can be used (for example, the PDU set can be decoded and used). Then, correspondingly, in a case that X% of the data packets in the PDU set succeed (a proportion of successful data packets in the PDU set to all data packets in the PDU set is greater than or equal to X %, where X may be an agreed value), the PDU set may be considered successful. However, X % resulting from FEC for different PDU sets may be the same or different.

Existing PDU set integrated handling information (PDU Set Integrated Handling Information, PSIHI) is sent only via a control plane, and can only indicate whether all PDUs of the PDU set are needed for the usage of the PDU set (The PDU PSIHI indicates whether all PDUs of the PDU Set are needed for the usage of the PDU Set). Based on a new scenario, the PSIHI should also be updated accordingly, for example, the PDU set can be used in a case that 80% of data packets in the PDU set are obtained. In this case, an operation for packet discarding based on a new PSIHI also changes, that is, a remaining data packet is discarded only in a case that 20% or more of data packets fail; otherwise, the data packet may still be sent. For example, in a case that an uplink PDU set includes 10 data packets, remaining data packets are discarded only in a case that 3 or more data packets fail.

Additionally, for some PDU sets, a 1st data packet usually carries control information. In a case that the 1st data packet fails to be transmitted, the PDU set cannot be used (in other words, in a case that the 1st data packet in the PDU set is lost, the PDU set cannot be decoded). Therefore, in another scenario, in a case that the 1st data packet in the PDU set fails, the PDU set may be considered failed. Then, the PSIHI should also be updated accordingly. For this scenario, in a case that the 1st data packet in the PDU set fails, the remaining data packet may be discarded.

Problem 1: In a scenario in which success criteria for different PDU sets vary, the following problems need to be resolved:
there are problems of how to extend a value of the PSIHI and how to guide UE to perform packet discarding based on new PSIHI information.

In a solution, the PSIHI may be extended to indicate one of the following: the PDU set can be used only in a case that X % or more of the data packets in the PDU set are obtained; and the PDU set can be used only in a case that the 1st data packet in the PDU set is obtained.

For a 1st value, in a case that (1-X %) or more of the data packets in the PDU set fail, the remaining data packet in the PDU set may be discarded.

For a 2nd value, in a case that the 1st data packet in the PDU set fails, the remaining data packet in the PDU set may be discarded.

In another solution, a Radio Access Network (RAN) may indicate one of the following to the UE:

In a case that Y % (1-X %) or more of the data packets in the PDU set fail, the remaining data packet in the PDU set may be discarded.

For a 2nd value, in a case that the 1st data packet in the PDU set fails, the remaining data packet in the PDU set may be discarded.

In an embodiment, in a case that it is determined that a criterion for determining that the PDU set succeeds or fails is applicable to an uplink and a downlink of a data flow, the RAN obtains the criterion for determining that the PDU set succeeds or fails and guides the User Equipment (UE) to perform a packet discarding operation.

Problem 2: In some scenarios, success or failure transmission criteria for different PDU sets in a same data flow are consistent. In this case, the criterion for determining that the PDU set succeeds or fails may be transmitted via control plane signaling. In some other scenarios, success transmission criteria for different PDU sets in a same data flow are inconsistent. That is, principles for determining success or failure of different PDU sets are different. For example, for a 1st PDU set, 100% reception may be needed to be considered successful. For a 2nd PDU set, it can be considered successful in a case that only 85% of data packets are successfully transmitted. In this case, transmitting, via the control plane, the criterion for determining that the PDU set succeeds or fails is not satisfactory.

In a solution, it may be assumed that a server side is aware of this situation. The success or failure criteria for different PDU sets can be set on a per-PDU (per PDU) basis. A Packet Service Anchor (PSA) UPF can detect this information and carry the information in a Gprs Tunneling Protocol-User Plane (GTP-U) header of the data packet. According to the success or failure criterion for the PDU set per PDU set, the RAN may determine whether transmission of the PDU set succeeds or fails, and whether to discard the remaining data packet.

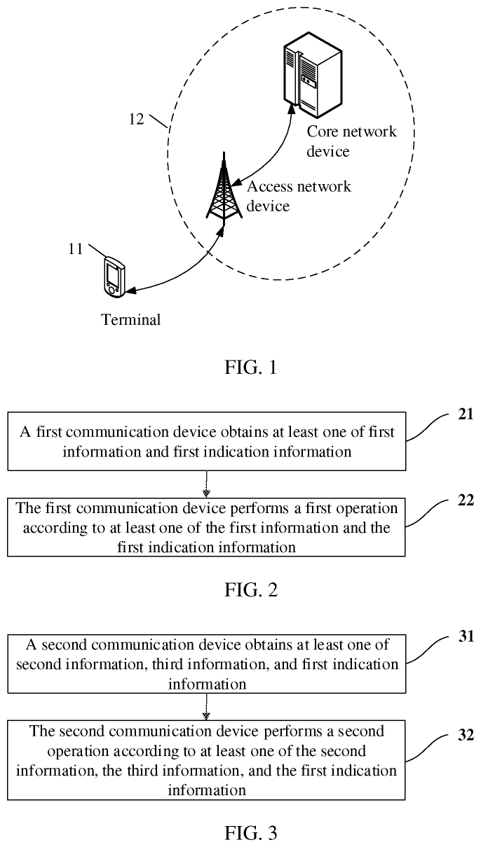

FIG. 1 is a block diagram of a wireless communication system to which an embodiment of this application is applicable. The wireless communication system includes a terminal 11 and a network side device 12. The terminal 11 may be a mobile phone, a tablet personal computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a Wearable Device, a flight vehicle, Vehicle User Equipment (VUE), ship-mounted equipment, Pedestrian User Equipment (PUE), a smart home (a home device with a wireless communication function, for example, a refrigerator, a television, a laundry machine, or a piece of furniture), a game console, a Personal Computer (PC), a teller machine, a self-service machine, or another terminal-side device. The wearable device includes: a smartwatch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in this embodiment of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AS), a Wireless Fidelity (WiFi) node, and the like. The base station may be referred to as a NodeB (NB), an Evolved Nodeb (eNB), a next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a home NodeB (HNB), a home evolved NodeB, a Transmission Reception Point (TRP), or another proper term in the art. The base station is not limited to a specific technical term, provided that same technical effects are achieved. It should be noted that in the embodiments of this application, only a base station in an NR system is used as an example for description, and a specific type of the base station is not limited.

The core network device may include but is not limited to at least one of the following: a core network node, a core network function, a Mobility Management Entity (MME), an access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF or L-NEF, a Binding Support Function (BSF), an Application Function (AF), and the like. It should be noted that in the embodiments of this application, only a core network device in the NR system is used as an example for description, and a specific type of the core network device is not limited.

Optionally, obtaining may be understood as obtaining from a configuration, receiving, receiving after a request is accepted, obtaining through self-learning, obtaining through derivation based on information that is not received, or obtaining through handling based on received information. This may be specifically determined based on an actual requirement, and is not limited in embodiments of this application. For example, when a piece of capability indication information sent by a device is not received, it may be derived that the device does not support the capability.

Optionally, sending may include broadcasting, broadcasting in a system message, and returning after a response is made to a request.

In an optional embodiment of this application, a communication device may include at least one of the following: a communication network element and a terminal.

In an embodiment of this application, the communication network element may include at least one of the following: a core network network element and a radio access network network element.

In this embodiment of this application, the core network network element may include but is not limited to at least one of the following: a core network device, a core network node, a core network function, a core network network element, a Mobility Management Entity (MME), an Access Management Function (AMF), a Session Management Function (SMF), a User Plane Function (UPF), a serving GW (SGW), a PDN gateway (PDN gateway), a Policy Control Function (PCF), a Policy and Charging Rules Function (PCRF), a Serving GPRS Support Node (SGSN), a Gateway GPRS Support Node (GGSN), and an application function.

In this embodiment of this application, the RAN network element may include but is not limited to at least one of the following: a radio access network device, a radio access network node, a radio access network function, a radio access network unit, a 3rd Generation Partnership Project (3GPP) radio access network, a non-3GPP radio access network, a Central Unit (CU), a Distributed Unit (DU), a base station, an evolved NodeB (eNB), a fifth generation mobile communication technology (Fifth Generation, 5G) base station (gNB), a Radio Network Controller (RNC), a NodeB, a Non-3GPP InterWorking Function (N3IWF), an Access Controller (AC) node, an Access Point (AP) device, a Wireless Local Area Network (WLAN) node, and the N3IWF.

The base station may be a Base Transceiver Station (BTS) in GSM or CDMA, or may be a base station (NodeB) in WCDMA, or may be an evolved NodeB (eNB or e-NodeB, evolved NodeB) in LTE or a 5G base station (gNB). This is not limited in the embodiments of this application.

In an embodiment of this application, UE may include one of the following: a terminal device, a terminal device and a card, and a card.

In an embodiment of this application, the card may include one of the following: a Subscriber Identity Module (SIM) card, a Universal Subscriber Identity Module (USIM) card, and an embedded Subscriber Identity Module (eSIM).

In an embodiment of this application, the terminal may include at least one of the following: a relay that supports a terminal function and a terminal that supports a relay function. The terminal may also be referred to as a terminal device or User Equipment (UE). The terminal may be a terminal-side device such as a mobile phone, a tablet personal computer, a laptop computer, a Personal Digital Assistant (PDA), a Mobile Internet Device (MID), a wearable device, or an in-vehicle device. It should be noted that a specific type of the terminal is not limited in embodiments of this application.

In an embodiment of this application, a PDU set may be understood or replaced with a data packet set, or may be understood or replaced with another equivalent name having the same meaning as the PDU set or the data packet set as defined in a future communication protocol.

In an embodiment of this application, a data flow is an abbreviation for a service data flow, and may also be referred to as a service flow.

In an embodiment of this application, a criterion (such as one of the following: a criterion for using a data packet set, a criterion for being incapable of using the data packet set, a criterion for the data packet set to succeed, and a criterion for the data packet set to fail) may be understood as one of the following: a standard, a condition, and a basis. For example, the criterion for the data packet set to succeed may be understood as a standard, a condition, or a basis for determining that the data packet set succeeds.

In an embodiment of this application, the failed data packet includes at least one of the following: a data packet that fails to be sent; a data packet that fails to be received; a data packet that fails to be transmitted; a data packet for which no receiving acknowledgment is received after the data packet is sent; one of the following present in a case that a Discard timer expires: the data packet (for example, a Packet Data Convergence Protocol Service Data Unit (PDCP) Service Data Unit (SDU)), and a PDCP SDU or a PDCP PDU corresponding to the data packet; and a PDCP SDU or a PSCP PDU in a case that the Discard timer expires.

In an embodiment of this application, that the data packet fails includes at least one of the following:
the data packet fails to be sent;
the data packet fails to be received;
the data packet fails to be transmitted;
no receiving acknowledgment is received after the data packet is sent; and
the data packet fails (such as a PDCP SDU) when the data packet or the PDCP SDU or the PDCP PDU corresponding to the data packet is present in a case that the Discard Timer expires.

In an embodiment, that a 1st data packet in the data packet set fails includes at least one of the following: the 1st data packet in the data packet set fails to be sent; the 1st data packet in the data packet set fails to be received; the 1st data packet in the data packet set fails to be transmitted; no receiving acknowledgment is received after the 1st data packet in the data packet set is sent; and the 1st data packet in the data packet set fails when the 1st data packet in the data packet set or a PDCP SDU or a PDCP PDU corresponding to the 1st data packet in the data packet set is still present in a case that the Discard timer expires.

In an embodiment of this application, that the data packet (such as a PDU, a PDCP SDU, or a PuTTY Secure Copy Protocol (PSCP) PDU) fails includes at least one of the following: the data packet fails to be sent; the data packet fails to be received; the data packet fails to be transmitted; no receiving acknowledgment is received after the data packet is sent; and the data packet (the PDCP SDU or the PSCP PDU) is still present in a case that the discard timer expires.

In an embodiment of this application, that a data packet (such as a PDU, a PDCP SDU, or a PSCP PDU) in a first data packet set includes at least one of the following:
the data packet in the first data packet set fails to be sent;
the data packet in the first data packet set fails to be received;
the data packet in the first data packet set fails to be transmitted;
no receiving acknowledgment is received after the data packet in the first data packet set is sent; and
the PDCP SDU or the PSCP PDU is still present in the first data packet set in a case that the discard timer expires.

In an embodiment of this application, the discard timer is a packet loss timer configured by a RAN device (such as a base station) for a terminal. It is not difficult to understand that in a case that the PDCP SDU (or PDU) is still present in the first data packet set when the discard timer expires, it indicates that the PDU SDU (or PDU) is not successfully transmitted, or fails.

In an embodiment, in a case that the PSCP PDU is still present when the discard timer expires, one of the following is determined: the PDCP PDU fails (for example, the data packet is the PDCP PDU), the PDCP SDU fails (for example, the PDCP SDU is the PSDCP SDU corresponding to the PSCP PDU, and the data packet is the PDCP SDU), the data packet corresponding to the PDCP PDU fails, and the data packet corresponding to the PDCP SDU fails (for example, the PDCP SDU is the PSDCP SDU corresponding to the PSCP PDU).

In an embodiment of this application, support includes one of the following: can apply, enable.

In an embodiment of this application, apply may also be referred to as one of the following: use, adopt, execute, perform.

In an embodiment, data packet set (such as PDU set) information corresponding to the data packet (such as the PDU, the PDCP SDU, or the PDCP PDU) is at least one of related information of a data packet set to which the data packet belongs, and related information of the data packet in the data packet set to which the data packet belongs (such as a sequence number of the data packet in the data packet set).

In an embodiment, the “data packet set information” may also be referred to as “PDU set information”.

In an embodiment of this application, the data packet set (such as the PDU set) information includes at least one of the following:
importance of the data packet set;
a size of the data packet set;
end indication information of the data packet set;
start indication information of the data packet set;
a sequence number of a data packet in the data packet set;
a sequence number of the data packet set; duration of the data packet set;
interval time between data packet sets or interval time between a data packet set and a next data packet set;
a periodicity of the data packet set;
handling information with the data packet set (such as the PDU set) as a whole;
a criterion for using the data packet set, or a criterion for being incapable of using the data packet set;
a criterion for the data packet set to succeed, or a criterion for the data packet set to fail; and
a criterion for discarding a data packet in the data packet set.

In an embodiment of this application, the PDU set information includes at least one of the following:
importance of the PDU set;
a size of the PDU set;
end indication information of the PDU set;
start indication information of the PDU set;
a sequence number of a data packet in the PDU set;
a sequence number of the PDU set; duration of the PDU set;
interval time between PDU sets or interval time between a PDU set and a next PDU set;
a periodicity of the PDU set;
handling information with the PDU set as a whole;
a criterion for using the PDU set, or a criterion for being incapable of using the PDU set;
a criterion for the PDU set to succeed, or a criterion for the PDU set to fail; and
a criterion for discarding a data packet in the PDU set.

In an embodiment of this application, the size of the PDU set refers to a PDU set size, for example, an amount of data, which may be measured by bytes, bits, or a quantity of data packets.

In an embodiment of this application, the end indication information of the PDU set is used to indicate whether a data packet carrying the end indication information of the PDU set is or is not an end data packet or a last data packet of the PDU set. The end indication information of the PDU set may be embodied by an indication, or may be embodied by being encoded together with other information.

In an embodiment of this application, the start indication information of the PDU set is used to indicate whether a data packet carrying the start indication information of the PDU set is or is not a start data packet or a 1st data packet of the PDU set. The start indication information of the PDU set may be embodied by an indication, or may be embodied by being encoded together with other information.

In an embodiment of this application, the sequence number of the data packet in the PDU set, for example, a PDU set includes a plurality of data packets, such as 5, and sequence numbers of the 5 data packets in the PDU set may be 1, 2, 3, 4, and 5 respectively.

In an embodiment of this application, the sequence number of the PDU set, for example, there are a plurality of PDU sets: a PDU set 1, a PDU set 2, and a PDU set 3, and sequence numbers of the PDU sets may be 1, 2, and 3 respectively.

In an embodiment of this application, the duration of the PDU set may be one of the following: interval time between receiving time of a last received data packet and receiving time of a 1st received data packet in the PDU set, and interval time between sending time of a last sent data packet and sending time of a 1st sent data packet in the PDU set.

In an embodiment of this application, the interval time between the PDU sets is the interval time between the PDU set and the next PDU set.

In an embodiment of this application, the periodicity of the PDU set means that the interval time between the PDU sets is balanced, reflecting a periodic characteristic.

Optionally, the first object includes at least one of the following: a first radio bearer (such as a Data Radio Bearer (DRB) or a logical channel), and a first Quality of Service (QoS) flow.

In an embodiment, the first QoS flow is mapped to a QoS flow of the first radio bearer.

In an embodiment, the first radio bearer is a radio bearer to which the first QoS flow is mapped.

In an embodiment of this application, PDU set QoS or a PDU set QoS parameter includes at least one of the following: a PDU Set Error Rate (PSER), a PDU Set Delay Budge (PSDB), and PDU Set Integrated Handling Information (PSIHI).

The PSIHI may be used to request integrated handling of the PDU set.

In another embodiment, the PDU set QoS further includes the importance of the PDU set. That is, the importance of the PDU set may or may not be the PDU set QoS.

In an embodiment of this application, applying the PDU set QoS includes at least one of the following: PDU set-level QoS guarantee, scheduling, time-frequency resource configuration, and the like for data according to the PDU set QoS.

The second communication device (RAN) applying PDU set handling on an uplink includes handling uplink data based on a PDU set parameter (including at least one of the PDU set QoS and the importance of the PDU set), such as scheduling, resource allocation, and configuration of a discard timer.

In an embodiment of this application, handling based on the importance of the PDU set includes packet discarding based on the importance of the PDU set.

In an embodiment of this application, packet discarding of the PDU set includes at least one of the following: packet discarding based on the importance of the PDU set, and PDU set integrated packet discarding.

In an embodiment of this application, applying handling based on the importance of the PDU set includes discarding a PDU set according to the importance of the PDU set in case of congestion, for example, discarding in ascending order of importance.

In an embodiment of this application, the PDU set QoS is used to implicitly indicate at least one of the following: PDU set QoS is applied to a downlink, and handling based on the PDU set QoS is applied to the downlink.

In an embodiment of this application, applying the importance of the PDU set implicitly indicates that the importance of the PDU set is applied to the downlink.

In an embodiment of this application, applying handling based on the importance of the PDU set implicitly indicates that handling based on the importance of the PDU set is applied to the downlink.

In this case, it is not difficult to understand that it may be indicated that only PDU set handling is applied to the uplink.

In this case, it is not difficult to understand that the fourth information may only indicate uplink support for PDU set handling.

In an embodiment of this application, applying or not applying the importance of the PDU set includes applying or not applying the importance of the PDU set to at least one of the uplink and the downlink.

In an embodiment of this application, applying or not applying handling based on the importance of the PDU set includes applying or not applying handling based on the importance of the PDU set to at least one of the uplink and the downlink.

In an optional embodiment of this application, the data packet set may be briefly referred to as a data set. The data packet set includes one or more data packets. Optionally, the data packet set has a boundary.

In an optional embodiment of this application, the data packet set is a concept in a cellular mobile communication network. The data packet set may be a segment formed by one or more data packets in a channel (for example, a QoS flow, a QoS subflow, or a radio bearer), or a set formed by one or more data packets.

In an optional embodiment of this application, the data packet may be a PDU packet data unit.

In an optional embodiment of this application, the data packet set may be one of the following: a packet data unit set PDU set, an instance of a PDU set, a PDU set category, an instance of a PDU set category, a data segment or a data packet set in a channel (for example, a QoS flow, a QoS subflow, or a radio bearer).

(1) In an embodiment, a PDU set category may include a plurality of PDU set instances. A PDU set category may be identified by using a PDU set identifier (for example, a QoS identifier at a PDU set level). A plurality of different PDU set instances of a same PDU set may be distinguished by using a data packet set sequence number (for example, a PDU set sequence number).

(2) In another embodiment, a PDU set category may include a plurality of PDU sets. The PDU set is the instance of the PDU set category. The PDU set category may be identified by using a PDU set identifier (for example, a QoS identifier at a PDU set level). A plurality of different PDU sets of a same PDU set category may be distinguished by using a data packet set sequence number (for example, a PDU set sequence number).

In an optional embodiment of this application, the data packet set category may be one of the following: a packet data unit set (PDU Set), and a channel (for example, a QoS flow, a QoS subflow, or a radio bearer). One data packet set category may correspond to a plurality of data packet sets. The data packet set is the instance of the data packet set category. The data packet set category may be identified by using a data packet set category identifier. The data packet set category identifier is, for example, the QoS identifier at the data packet set level. In this case, a plurality of data packet sets may be distinguished by using a data packet set sequence number.

In an embodiment, the one or more data packet sets are of a same category or different categories. Data packet sets of different categories may be distinguished by using a data packet set identifier. Different data packet sets of a same category may be distinguished by using a data packet set sequence number.

In an optional embodiment of this application, a data packet set (for example, a PDU set) includes one or more data packets (for example, PDUs). PDU set: the PDU set includes one or more PDUs. These PDUs carry a payload (for example, a frame or a video slice) of an information unit generated at an application level. In some implementations, at an application layer, all PDUs in the PDU set are needed to use corresponding information units. In other implementations, the application layer may still recover all or a part of the information units when some PDUs are lost.

With reference to the accompanying drawings, an information handling method and handling apparatus, a communication device, and a readable storage medium provided in the embodiments of this application are described in detail by using some embodiments and application scenarios thereof.

Referring to FIG. 2, an embodiment of this application provides an information handling method, applied to a first communication device. The first communication device includes but is not limited to one of the following: a terminal, and a core network device (an application function). The method includes the following steps:
Step 21: The first communication device obtains at least one of first information and first indication information.
Step 22: The first communication device performs a first operation according to at least one of the first information and the first indication information.

The first information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set.

The first operation includes at least one of the following:
determining that a first data packet set succeeds or fails;
discarding a data packet in the first data packet set; and
handling data with the data packet set as a whole.

The first indication information is used to indicate at least one of the following: performing packet discarding according to the first information; discarding a data packet in a failed data packet set; and discarding the data packet in the data packet set.

Optionally, handling data with the data packet set as a whole means handling data at a granularity of the data packet set. Handling information with the data packet set as a whole (such as PDU Set Integrated Handling Information) is handling information at a granularity of the data packet set. Optionally, the handling information with the data packet set as a whole or the criterion for using the data packet set is used to indicate at least one of the following:
all data packets in the data packet set are needed to use the data packet set;
data packets whose proportion is greater than or equal to a first proportion in the data packet set are needed to use the data packet set; and
at least a 1st data packet in the data packet set is needed to use the data packet set.

In an embodiment, the criterion for the data packet set to succeed may be understood as a criterion for determining that the data packet set succeeds. The criterion for the data packet set to fail may be understood as a criterion for determining that the data packet set fails.

In an embodiment, discarding the data packet in the data packet set is used to indicate at least one of the following: discarding the data packet at a granularity of the data packet set, discarding all data packets in the data packet set, and discarding a remaining data packet in the data packet set (such as all remaining data packets (such as PDUs, PDCP SDUs, or PDCP PDUs)).

Optionally, all data packets in the data packet set are, for example, one of the following: all PDCP SDUs in the data packet set, and all PDCP PDUs in the data packet set (where the PDCP PDU is a PSCP PDU corresponding to the PSCP SDU in the data packet set).

Optionally, the remaining data packet in the data packet set (such as the PDU, the PDCP SDU, or the PDCP PDU) includes at least one of the following: a data packet in the data packet set in a cache; a data packet in the data packet set that has not been sent; a PDCP SDU in the data packet set present in a case that the discard timer expires; and a PDCP PDU in the data packet set (such as a PSCP PDU corresponding to the PDCP SDU in the data packet set) present in a case that the discard timer expires.

Optionally, the data packet in the data packet set in the cache may be a data packet (such as a PDCP SDU or a PDCP PDU) in the data packet set in a PDCP layer or SDAP layer cache of the first communication device.

In an embodiment, discarding the data packet in the first data packet set includes at least one of the following: discarding all data packets in the first data packet set, and discarding a remaining data packet (such as all remaining data packets (such as PDUs, PDCP SDUs, or PDCP PDUs)) in the first data packet set.

Optionally, all data packets in the first data packet set are, for example, one of the following: all PDCP SDUs in the first data packet set, and all PDCP PDUs in the first data packet set (where the PDCP PDU is a PSCP PDU corresponding to the PSCP SDU in the data packet set).

Optionally, the remaining data packet in the first data packet set (such as the PDU, the PDCP SDU, or the PDCP PDU) includes at least one of the following: a data packet in the data packet set in a cache; a data packet in the first data packet set that has not been sent; a PDCP SDU in the first data packet set present in a case that the discard timer expires; and a PDCP PDU in the first data packet set (such as a PSCP PDU corresponding to the PDCP SDU in the data packet set) present in a case that the discard timer expires.

Optionally, the data packet in the first data packet set in the cache may be a data packet (such as a PDCP SDU or a PDCP PDU) in the first data packet set in a PDCP layer or SDAP layer cache of the first communication device.

In an embodiment, the obtaining the first information may be that the first communication device locally has the first information, for example, the first communication device obtains the first information through local configuration or self-learning (such as reading a protocol header of a data packet), or obtains the first information from an AS layer of the first communication device or a higher layer (such as a Non-Access Stratum (NAS) or an application layer) of the first communication device.

In another embodiment, the obtaining the first information may be that the first communication device obtains the first information from a source device. The source device includes at least one of the following: a second communication device, a fourth communication device, a core network device, and a RAN device.

In an embodiment, the first communication device obtains the first indication information from the source device. The source device includes at least one of the following: the second communication device, the fourth communication device, the core network device, and the RAN device.

It is not difficult to understand that there may be, but is not limited to, the following combinations:
(1) The first communication device receives and obtains the first information from the source device and performs the first operation according to the first information.
(2) The first communication device obtains the first information through local configuration or self-learning, and the first communication device performs the first operation according to the first information.
(3) The AS layer of the first communication device obtains the first information from the higher layer (such as the NAS layer or the application layer) of the first communication device, and the AS layer of the first communication device performs the first operation according to the first information.
(4) The first communication device receives and obtains the first information and the first indication information from the source device, and performs the first operation according to the first information and the first indication information.
(5) The first communication device receives and obtains the first indication information from the source device, obtains the first information through local configuration or self-learning, and performs the first operation according to the first information and the first indication information.
(6) The first communication device receives and obtains the first indication information from the RAN device, the AS layer of the first communication device obtains the first information from the higher layer (such as the NAS layer or the application layer) of the first communication device, and the AS layer of the first communication device performs the first operation according to the first information and the first indication information.
(7) The NAS layer of the first communication device receives and obtains the first indication information from the Core Network (CN) device, and the NAS layer of the first communication device may send the first indication information to the AS layer of the first communication device. The AS layer of the first communication device obtains the first information from the higher layer (such as the NAS layer or the application layer) of the first communication device. The AS layer of the first communication device performs the first operation according to the first information and the first indication information.
(8) The NAS layer of the first communication device receives and obtains the first indication information from the CN device, and the NAS layer of the first communication device may send the first indication information to the AS layer of the first communication device. The AS layer of the first communication device locally has the first information (for example, the AS layer of the first communication device obtains the first information through local configuration or self-learning). The AS layer of the first communication device performs the first operation according to the first information and the first indication information.

In an embodiment, that the data packet succeeds includes one of the following: the data packet is successfully sent; the data packet is successfully received; the PDCP SDU is no longer present in a case that the discard timer expires; and the PDCP PDU is no longer present in a case that the discard timer expires.

In an embodiment, that the data packet fails includes one of the following: the data packet fails to be sent; the data packet fails to be received; the PDCP SDU is present in a case that the discard timer expires; and the PDCP PDU is present in a case that the discard timer expires.

In an embodiment, that the first data packet set succeeds means that the first data packet set is successfully sent or the first data packet set is successfully received; and that the first data packet set fails means that the first data packet set fails to be sent or received.

In an embodiment, the first data packet set is a data packet set in an uplink direction, and the data packet is an uplink packet.

Optionally, the first communication device obtaining the first information includes:
the first communication device receiving the first information sent by the second communication device or the fourth communication device;
or
the first communication device obtaining the first information through local configuration or self-learning;
or
the access stratum AS of the first communication device obtaining the first information via the higher layer of the first communication device.

Optionally, the first communication device obtaining the first information includes:
the first communication device receiving the first indication information sent by the second communication device or the fourth communication device;
or
the access stratum AS of the first communication device obtaining the first indication information from the non-access stratum NAS or the application layer of the first communication device.

Optionally, the discarding a data packet in the first data packet set includes discarding at least one of the following: all data packets in the first data packet set, a remaining data packet in the first data packet set, a data packet in the first data packet set in a cache, an untransmitted data packet in the first data packet set, an unsuccessfully transmitted data packet in the first data packet set, a failed data packet in the first data packet set, a packet data convergence protocol service data unit PDCP SDU in the first data packet set, and a PDCP protocol data unit PDU in the first data packet set.

In an embodiment, the first data packet set is any or a specific data packet set.

In an embodiment, the data packet in the first data packet set includes at least one of the following: the PDCP SDU in the first data packet set (for example, the PDCP SDU has not been constructed into the PDCP PDU), and the PDCP PDU in the first data packet set (for example, the PDCP PDU has not been transmitted to a lower layer (namely, a protocol layer below PDCP, such as RLC, MAC, or a physical layer)). Optionally, the PDCP PDU in the first data packet set may be a PDCP PDU corresponding to the PDCP SDU in the first data packet set.

Optionally, all data packet in the first data packet set are, for example, one of the following: all PDCP SDUs in the first data packet set, and all PDCP PDUs in the first data packet set (where the PDCP PDU is a PSCP PDU corresponding to the PSCP SDU in the first data packet set).

Optionally, the remaining data packet in the first data packet set (such as the PDU, the PDCP SDU, or the PDCP PDU) includes at least one of the following: a data packet in the data packet set in a cache; a data packet in the first data packet set that has not been sent; a PDCP SDU in the first data packet set present in a case that the discard timer expires; and a PDCP PDU in the first data packet set (such as a PSCP PDU corresponding to the PDCP SDU in the data packet set) present in a case that the discard timer expires.

Optionally, the data packet in the first data packet set in the cache may be a data packet (such as a PDCP SDU or a PDCP PDU) in the first data packet set in a PDCP layer or SDAP layer cache of the first communication device.

For example, in a case that a data packet set includes 10 data packets, first four data packets succeed, and a 5th data packet fails, remaining five data packets are remaining data packets, or the 5th data packet and the remaining five data packets are remaining data packets.

It is not difficult to understand that some data packets in the cache are deleted only after a sending success acknowledgment indication is received. Therefore, in a case that the 5th data packet fails to be sent, the 5th data packet is present in the cache. As a result, the 5th data packet is also determined as a remaining data packet.

In an embodiment, the PDCP SDU in the first data packet set includes: the PDCP SDU in the first data packet set, where the PDCP SDU has not been constructed into the PDCP PDU.

In an embodiment, the PDCP PDU in the first data packet set includes at least one of the following: the PDCP PDU in the first data packet set (the PSCP PDU corresponding to the PDCP SDU in the first data packet set), where the PDCP PDU has not been transmitted to the lower layer (namely, the protocol layer below PDCP, such as Radio Link Control (RLC), Medium Access Control (MAC), or the physical layer); and
the PDCP PDU in the first data packet set (the PSCP PDU corresponding to the PDCP SDU in the first data packet set), where the PDCP PDU has not been transmitted to the lower layer (namely, the protocol layer below PDCP, such as RLC, MAC, or the physical layer).

In an embodiment, the second communication device is a radio access network device (such as a base station), and the fourth communication device is a core network device (such as an SMF, a PCF, or an AF).

In an embodiment, obtaining the first information through self-learning includes self-learning the first information from the packet header (such as the protocol header) of the first data packet in the first data packet set.

In an embodiment, the protocol includes but is not limited to at least one of the following: Real-time Transport Protocol (RTP), Secure Real-time Transport Protocol (SRTP), Quick UDP Internet Connections (QUIC), and Moving Picture Experts Group (MPEG).

Optionally, the discarding a data packet in the first data packet set includes: discarding the data packet in the first data packet set in a case that a first condition is met.

The first condition includes at least one of the following:
the first information is obtained;
the first indication information is obtained;
that the first data packet set fails is determined;
the first data packet set does not meet at least one of the handling information with the data packet set as a whole, the criterion for the data packet set to succeed, and the criterion for using the data packet set; and
the first data packet set meets at least one of the criterion for the data packet set to fail, the criterion for being incapable of using the data packet set, and the criterion for discarding the data packet in the data packet set.

Optionally, the determining that a first data packet set succeeds includes:
in a case that a second condition is met, determining that the first data packet set succeeds.

The second condition includes at least one of the following:
the first data packet set meets at least one of the handling information with the data packet set as a whole, the criterion for the data packet set to succeed, and the criterion for using the data packet set.

Optionally, the determining that a first data packet set fails includes:
in a case that a third condition is met, determining that the first data packet set fails.

The third condition includes at least one of the following:
the first data packet set does not meet at least one of the handling information with the data packet set as a whole, the criterion for the data packet set to succeed, and the criterion for using the data packet set; and
the first data packet set meets at least one of the criterion for the data packet set to fail, the criterion for being incapable of using the data packet set, and the criterion for discarding the data packet in the data packet set.

Optionally, the handling information with the data packet set as a whole or the criterion for using the data packet set is used to indicate at least one of the following:
all data packets in the data packet set are needed to use the data packet set;
data packets whose proportion is greater than or equal to a first proportion in the data packet set are needed to use the data packet set; and
at least a 1st data packet in the data packet set is needed to use the data packet set.

The N-th proportion is a proportion of a quantity (or size) of data packets in a data packet set to a quantity (or size) of all data packets in the data packet set. The N-th proportion is, for example, the first proportion, the second proportion, the third proportion, or the fourth proportion.

Optionally, the N-th proportion is a proportion of a quantity (or size) of data packets in a data packet set to a quantity (or size) of all data packets in the data packet set. The N-th proportion is, for example, the first proportion, the second proportion, the third proportion, or the fourth proportion.

Optionally, that the first data packet set meets the handling information with the data packet set as a whole is used to indicate at least one of the following:
in a case that the handling information with the data packet set as a whole or the criterion for using the data packet set is used to indicate that the data packets whose proportion is greater than or equal to the first proportion in the data packet set are needed to use the data packet set, a proportion of successful data packets in the first data packet set is greater than or equal to the first proportion, or a proportion of failed data packets in the first data packet set is less than or equal to a value obtained by subtracting the first proportion from 1; and
in a case that the handling information with the data packet set as a whole or the criterion for using the data packet set is used to indicate that at least the 1st data packet in the data packet set is needed to use the data packet set, a 1st data packet in the first data packet set succeeds, or the 1st data packet in the first data packet set does not fail;
or
that the first data packet set does not meet the handling information with the data packet set as a whole includes at least one of the following:
in a case that the handling information with the data packet set as a whole or the criterion for using the data packet set is used to indicate that the data packets whose proportion is greater than or equal to the first proportion in the data packet set are needed to use the data packet set, a proportion of successful data packets in the first data packet set is less than or equal to the first proportion, or a proportion of failed data packets in the first data packet set is greater than or equal to a value obtained by subtracting the first proportion from 1; and
in a case that the handling information with the data packet set as a whole or the criterion for using the data packet set is used to indicate that at least the 1st data packet in the data packet set is needed to use the data packet set, a 1st data packet in the first data packet set fails.

In an embodiment, the proportion of data packets is one of the following: a proportion of a quantity of data packets in a data packet set to a total quantity of all data packets in the data packet set; and a proportion of a size of data packets in a data packet set to a total size of all data packets in the first data packet set.

In an embodiment, the proportion of successful data packets in the first data packet set is: a proportion of a quantity (or size) of successful data packets in the first data packet set to a quantity (or size) of all data packets in the first data packet set.

In an embodiment, the proportion of failed data packets in the first data packet set is: a proportion of a quantity (or size) of failed data packets in the first data packet set to a quantity (or size) of all data packets in the first data packet set.

In an embodiment, that the proportion of successful data packets in the first data packet set is greater than or equal to the first proportion means that the quantity (or size) of successful data packets in the first data packet set is greater than or equal to the first proportion of the quantity (or size) of all the data packets in the first data packet set.

That the proportion of failed data packets in the first data packet set is less than or equal to the third proportion means that the quantity (or size) of failed data packets in the first data packet set is less than or equal to the third proportion of the quantity (or size) of all the data packets in the first data packet set.

A meaning of a proportion of other packets is analogous.

In an embodiment, that the proportion of failed data packets in the first data packet set is less than or equal to the third proportion includes:
in a case that the discard timer expires, a quantity (or size) of PDCP SDUs (or PSCP PDUs) in the first data packet set is less than or equal to the third proportion of a quantity (or size) of all PDCP SDUs in the first data packet set (for example, in a case that the discard timer expires, a quantity (or size) of present PDCP SDUs (or PSCP PDUs) in the first data packet set is less than or equal to the third proportion of the quantity (or size) of all the PDCP SDUs in the first data packet set).

In an embodiment, that the 1st data packet in the first data packet set fails includes: a 1st PDCP SDU in the first data packet set is present in a case that the discard timer expires.

In another embodiment, that the 1st data packet in the first data packet set succeeds includes: a 1st PDCP SDU in the first data packet set is not present in a case that the discard timer expires. It is not difficult to understand that in a case that the 1st PDCP SDU has been successfully transmitted, the 1st PDCP SDU is no longer present after being deleted.

Optionally, the criterion for using the data packet set is used to indicate at least one of the following:
the data packet set succeeds;
all the data packets in the data packet set succeed before the data packet set can be used;
the data packets whose proportion is greater than or equal to the first proportion in the data packet set succeed before the data packet set can be used;
data packets whose proportion is less than or equal to a third proportion in the data packet set fail before the data packet set can be used; and
at least the 1st data packet in the data packet set succeeds before the data packet set can be used;
or
the criterion for being incapable of using the data packet set is used to indicate at least one of the following:
the data packet set fails;
in a case that one or more data packets in the data packet set fail, the data packet set cannot be used;
in a case that data packets whose proportion is less than or equal to the first proportion in the data packet set succeed, the data packet set cannot be used;
in a case that data packets whose proportion is greater than or equal to a third proportion in the data packet set fail, the data packet set cannot be used; and
in a case that the 1st data packet in the data packet set fails, the data packet set cannot be used.

In an embodiment, in a case that the handling information with the data packet set as a whole is “all data packets in the data packet set are needed to use the data packet set”, that the handling information with the data packet set as a whole is not met means that at least one data packet in the data packet set fails.

Optionally, the criterion for the data packet set to succeed is used to indicate at least one of the following:
in a case that a 1st data packet in the data packet set succeeds, determining that the data packet set succeeds;
in a case that data packets whose proportion is greater than or equal to a second proportion in the data packet set succeed, determining that the data packet set succeeds; and
in a case that all data packets in the data packet set succeed, determining that the data packet set succeeds.

In an embodiment, the first proportion is the same as the second proportion. In another embodiment, the first proportion is different from the second proportion.

In an embodiment, that the first data packet set meets the criterion for the data packet set to succeed is used to indicate at least one of the following:
in a case that the criterion for the data packet set to succeed is used to indicate that the data packet set is determined to be successful in a case that the 1st data packet in the data packet set succeeds, a 1st data packet in the first data packet set succeeds, or the 1st data packet in the first data packet set does not fail;
in a case that the criterion for the data packet set to succeed is used to indicate that the data packet set is determined to be successful in a case that data packets whose proportion is greater than or equal to the second proportion in the data packet set succeed, the proportion of successful data packets in the first data packet set is greater than or equal to the second proportion, or the proportion of failed data packets in the first data packet set is less than or equal to the value obtained by subtracting the second proportion from 1; and
in a case that the criterion for the data packet set to succeed is used to indicate that the data packet set is determined to be successful in a case that all data packets in the data packet set succeed, all data packets in the first data packet set succeed, or a quantity of failed data packets in the first data packet set is 0.

Optionally, the criterion for the data packet set to fail is used to indicate at least one of the following:
in a case that one or more data packets in the data packet set fail, determining that the data packet set fails;
in a case that data packets whose proportion is greater than or equal to a third proportion in the data packet set fail, determining that the data packet set fails; and
in a case that a 1st data packet in the data packet set fails, determining that the data packet set fails.

In an embodiment, the value of the third proportion is equal to the value obtained by subtracting the first proportion from 1, or the value obtained by subtracting the second proportion from 1.

In an embodiment, that the first data packet set meets the criterion for the data packet set to fail is used to indicate at least one of the following:
in a case that the criterion for the data packet set to fail is used to indicate that the data packet set is determined to be failed in a case that one or more data packets in the data packet set fail, one or more data packets in the first data packet set fail;
in a case that the criterion for the data packet set to fail is used to indicate that the data packet set is determined to be failed in a case that data packets whose proportion is greater than or equal to the third proportion in the data packet set fail, data packets whose proportion is greater than or equal to the third proportion in the first data packet set fail, or data packets whose proportion is less than or equal to (the value obtained by subtracting the third proportion from 1) in the first data packet set succeed; and
in a case that the criterion for the data packet set to fail is used to indicate that the data packet set is determined to be failed in a case that the 1st data packet in the data packet set fails, the 1st data packet in the first data packet set fails.

Optionally, the criterion for discarding the data packet in the data packet set is used to indicate at least one of the following:
in a case that one or more data packets in the data packet set fail, the data packet in the data packet set is discarded or the data packet set cannot be used;
in a case that a 1st data packet in the data packet set fails, the data packet in the data packet set is discarded or the data packet set cannot be used; and
in a case that data packets whose proportion is greater than or equal to a fourth proportion in the data packet set fail, the data packet in the data packet set is discarded or the data packet set cannot be used.

In an embodiment, the value of the second proportion is equal to the value obtained by subtracting the second proportion from 1, or the value obtained by subtracting the first proportion from 1.

In an embodiment, the third proportion is the same as the fourth proportion. In another embodiment, the third proportion is different from the fourth proportion.

Optionally, the failed data packet includes at least one of the following: a data packet that fails to be sent; a data packet that fails to be received; a data packet that fails to be transmitted; a data packet for which no receiving acknowledgment is received after the data packet is sent; one of the following present in a case that a Discard timer expires: the data packet, and a PDCP SDU or a PDCP PDU corresponding to the data packet; and a PDCP SDU or a PSCP PDU in a case that the Discard timer expires;
or
that the data packet fails includes at least one of the following:
the data packet fails to be sent;
the data packet fails to be received;
the data packet fails to be transmitted;
no receiving acknowledgment is received after the data packet is sent; and
the data packet fails when the data packet or the PDCP SDU or the PDCP PDU corresponding to the data packet is present in a case that the Discard timer expires.

In an embodiment, the data packet or the 1st data packet includes one of the following: a PDU, a PDCP SDU, and a PDCP PDU.

In an embodiment, the PDCP SDU in the first data packet set includes: the PDCP SDU in the first data packet set, where the PDCP SDU has not been constructed into the PDCP PDU.

In an embodiment, the PDCP PDU in the first data packet set includes at least one of the following: the PDCP PDU in the first data packet set (the PSCP PDU corresponding to the PDCP SDU in the first data packet set), where the PDCP PDU has not been transmitted to the lower layer (for example, a protocol layer below PDCP, such as RLC, MAC, or a physical layer).

In an embodiment, that the PDCP SDU is present in a case that the Discard timer expires includes: the PDCP SDU has not been constructed into the PDCP PDU in a case that the discard timer expires.

In an embodiment, that the PDCP PDU is present in a case that the Discard timer expires includes: the PDCP PDU has not been transmitted to the lower layer (for example, the protocol layer below PDCP, such as RLC, MAC, or the physical layer) in a case that the discard timer expires.

In an embodiment, that a 1st data packet in the data packet set fails includes at least one of the following: the 1st data packet in the data packet set fails to be sent; the 1st data packet in the data packet set fails to be received; the 1st data packet in the data packet set fails to be transmitted; no receiving acknowledgment is received after the 1st data packet in the data packet set is sent; and the 1st data packet in the data packet set fails when the 1st data packet in the data packet set or a PDCP SDU or a PDCP PDU corresponding to the 1st data packet in the data packet set is still present in a case that the Discard timer expires.

In an embodiment, there is the PDCP SDU or the PSCP PDU in a case that the discard timer expires, for example, the PDCP SDU or the PSCP PDU is present in a case that the discard timer expires.

In an embodiment, there is the PDCP SDU or the PSCP PDU in a case that the discard timer expires, for example, the PDCP SDU or the PSCP PDU is present in a case that the discard timer expires.

Optionally, before the first communication device performs the first operation according to at least one of the first information and the first indication information, the method further includes:
sending third information to the second communication device or the fourth communication device, where the third information is used to indicate one of the following: inconsistent handling of all data packet sets with the data packet set as a whole, and consistent handling of all data packet sets with the data packet set as a whole.

Inconsistent handling of all data packet sets with the data packet set as a whole means that handling of all data packet sets in a first object with the data packet set as a whole is inconsistent, where the first object includes at least one of the following: a data flow, a radio bearer, and a quality of service QoS flow.

In an embodiment, consistent handling of all data packet sets with the data packet set as a whole means that handling of all data packet sets in a first object with the data packet set as a whole is consistent, where the first object includes at least one of the following: a data flow, a radio bearer, and a quality of service QoS flow.

Optionally, consistent handling of all data packet sets with the data packet set as a whole means that at least one of the following for all data packet sets is consistent:
handling information with the data packet set as a whole;
the criterion for using the data packet set, or the criterion for being incapable of using the data packet set;
the criterion for the data packet set to succeed, or the criterion for the data packet set to fail; and
the criterion for discarding the data packet in the data packet set.

According to this embodiment of this application, the first communication device obtains at least one of the first information and the first indication information. Based on at least one of the first information and the first indication information, the first communication device can determine that the first data packet set succeeds or fails, or discard the data packet in the first data packet set, thereby avoiding transmission of unnecessary data packets, saving network resources, and effectively alleviating pressure on network resources.

Referring to FIG. 3, an embodiment of this application provides an information handling method, applied to a second communication device. The second communication device includes but is not limited to a radio access network device (such as a base station, or a source RAN device for terminal handover). The method includes the following steps:

Step 31: The second communication device obtains at least one of second information, third information, and first indication information.

Step 32: The second communication device performs a second operation according to at least one of the second information, the third information, and the first indication information.

The second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set.

The second operation includes at least one of the following:
determining that a first data packet set succeeds or fails;
discarding a data packet in the first data packet set;
sending at least one of first information and the first indication information to a first communication device; and
handling data with the data packet set as a whole.

The first information is used to indicate at least one of the following:
the handling information with the data packet set as a whole;
the criterion for using the data packet set, or the criterion for being incapable of using the data packet set;
the criterion for the data packet set to succeed, or the criterion for the data packet set to fail; and
the criterion for discarding the data packet in the data packet set.

The first indication information is used to indicate at least one of the following: performing packet discarding according to the first information; discarding a data packet in a failed data packet set; and discarding the data packet in the data packet set; and
the third information is used to indicate one of the following information: inconsistent handling of all data packet sets with the data packet set as a whole, and consistent handling of all data packet sets with the data packet set as a whole.

In an embodiment, the first information and the second information have a same value.

In another embodiment, the first information and the second information have different values. For example, the second information includes the handling information with the data packet set as a whole. The first information may include at least one of the following: the criterion for discarding the data packet in the data packet set, and the criterion for the data packet set to fail.

Optionally, handling data with the data packet set as a whole means handling data at a granularity of the data packet set. Handling information with the data packet set as a whole (such as PDU Set Integrated Handling Information) is handling information at a granularity of the data packet set. Optionally, the handling information with the data packet set as a whole or the criterion for using the data packet set is used to indicate at least one of the following:
all data packets in the data packet set are needed to use the data packet set;
data packets whose proportion is greater than or equal to a first proportion in the data packet set are needed to use the data packet set; and
at least a 1st data packet in the data packet set is needed to use the data packet set.

In an embodiment, the criterion for the data packet set to succeed may be understood as a criterion for determining that the data packet set succeeds. The criterion for the data packet set to fail may be understood as a criterion for determining that the data packet set fails.

In an embodiment, discarding the data packet in the data packet set is used to indicate at least one of the following: discarding the data packet at a granularity of the data packet set, discarding all data packets in the data packet set, discarding all PDCP SDUs in the data packet set, discarding all PDCP PDUs in the data packet set (where the PDCP PDU is a PSCP PDU corresponding to the PSCP SDU in the first data packet set), and discarding a remaining data packet in the data packet set (such as all remaining data packets (such as PDUs, PDCP SDUs, or PDCP PDUs)).

Optionally, all data packets in the data packet set are, for example, one of the following: all PDCP SDUs in the data packet set, and all PDCP PDUs in the data packet set (where the PDCP PDU is a PSCP PDU corresponding to the PSCP SDU in the data packet set).

Optionally, the remaining data packet in the data packet set (such as the PDU, the PDCP SDU, or the PDCP PDU) includes at least one of the following: a data packet in the data packet set in a cache; a data packet in the data packet set that has not been sent; a PDCP SDU in the data packet set present in a case that the discard timer expires; and a PDCP PDU in the data packet set (such as a PSCP PDU corresponding to the PDCP SDU in the data packet set) present in a case that the discard timer expires.

Optionally, the data packet in the data packet set in the cache may be a data packet (such as a PDCP SDU or a PDCP PDU) in the data packet set in a PDCP layer or SDAP layer cache of the first communication device.

In an embodiment, discarding the data packet in the first data packet set includes at least one of the following: discarding all data packets in the first data packet set, discarding all PDCP SDUs in the first data packet set, discarding all PDCP PDUs in the first data packet set (where the PDCP PDU is a PSCP PDU corresponding to the PSCP SDU in the first data packet set), and discarding a remaining data packet in the first data packet set (such as all remaining data packets (such as PDUs, PDCP SDUs, or PDCP PDUs)).

Optionally, all data packets in the first data packet set are, for example, one of the following: all PDCP SDUs in the first data packet set, and all PDCP PDUs in the first data packet set (where the PDCP PDU is a PSCP PDU corresponding to the PSCP SDU in the data packet set).

Optionally, the remaining data packet in the first data packet set (such as the PDU, the PDCP SDU, or the PDCP PDU) includes at least one of the following: a data packet in the data packet set in a cache; a data packet in the first data packet set that has not been sent; a PDCP SDU in the first data packet set present in a case that the discard timer expires; and a PDCP PDU in the first data packet set (such as a PSCP PDU corresponding to the PDCP SDU in the data packet set) present in a case that the discard timer expires.

Optionally, the data packet in the first data packet set in the cache may be a data packet (such as a PDCP SDU or a PDCP PDU) in the first data packet set in a PDCP layer or SDAP layer cache of the first communication device.

Optionally, the first data packet set is a data packet set in a downlink direction, or the data packet in the first data packet set is a downlink data packet.

Optionally, the second communication device obtaining the second information includes:
the second communication device receiving the second information sent by a fourth communication device; or
the second communication device obtaining the second information from a received data packet.

In an embodiment, the fourth communication device is a core network device (such as an SMF, a PCF, an AF).

In an embodiment, the second communication device obtaining the second information from the received data packet includes obtaining the second information from a packet header (such as a protocol header) of a first data packet in the first data packet set.

In an embodiment, the protocol includes but is not limited to at least one of the following: RTP, SRTP, QUIC, and MPEG.

Optionally, the second communication device obtaining the third information includes:
the second communication device receiving the third information sent by at least one of the first communication device and a fourth communication device.

In an embodiment, the third information received from the first communication device includes: third information corresponding to a data packet set in an uplink direction.

In an embodiment, the third information received from the fourth communication device includes: third information corresponding to a data packet set in a downlink direction.

Optionally, the second communication device (such as the RAN) exchanges information with the fourth communication device (such as the SMF) via a fifth communication device (such as an AMF). For example, the second communication device (such as the RAN) sends information to the fifth communication device (such as the AMF), and the fifth communication device (such as the AMF) then sends the information to the fourth communication device (such as the SMF); and vice versa. The fourth communication device (such as the SMF) sends information to the fifth communication device (such as the AMF), and the second communication device (such as the RAN) then sends the information to the fourth communication device (such as the SMF).

Optionally, the discarding a data packet in the first data packet set includes discarding at least one of the following: all data packets in the first data packet set, a remaining data packet in the first data packet set, a data packet in the first data packet set in a cache, an untransmitted data packet in the first data packet set, an unsuccessfully transmitted data packet in the first data packet set, a failed data packet in the first data packet set, a PDCP SDU in the first data packet set, and a PDCP PDU in the first data packet set.

In an embodiment, the data packet in the first data packet set includes at least one of the following: the PDCP SDU in the first data packet set (for example, the PDCP SDU has not been constructed into the PDCP PDU), and the PDCP PDU in the first data packet set (for example, the PDCP PDU has not been transmitted to a lower layer (namely, a protocol layer below PDCP, such as RLC, MAC, or a physical layer)). Optionally, the PDCP PDU in the first data packet set may be a PDCP PDU corresponding to the PDCP SDU in the first data packet set.

Optionally, all data packet in the first data packet set are, for example, one of the following: all PDCP SDUs in the first data packet set, and all PDCP PDUs in the first data packet set (where the PDCP PDU is a PSCP PDU corresponding to the PSCP SDU in the first data packet set).

Optionally, the remaining data packet in the first data packet set (such as the PDU, the PDCP SDU, or the PDCP PDU) includes at least one of the following: a data packet in the data packet set in a cache; a data packet in the first data packet set that has not been sent; a PDCP SDU in the first data packet set present in a case that the discard timer expires; and a PDCP PDU in the first data packet set (such as a PSCP PDU corresponding to the PDCP SDU in the data packet set) present in a case that the discard timer expires.

Optionally, the data packet in the first data packet set in the cache may be a data packet (such as a PDCP SDU or a PDCP PDU) in the first data packet set in a PDCP layer or SDAP layer cache of the second communication device.

For example, in a case that a data packet set includes 10 data packets, first four data packets succeed, and a 5th data packet fails, remaining five data packets are remaining data packets, or the 5th data packet and the remaining five data packets are remaining data packets.

It is not difficult to understand that some data packets in the cache are deleted only after a sending success acknowledgment indication is received. Therefore, in a case that the 5th data packet fails to be sent, the 5th data packet is present in the cache. As a result, the 5th data packet is also determined as a remaining data packet.

In an embodiment, the PDCP SDU in the first data packet set includes: the PDCP SDU in the first data packet set, where the PDCP SDU has not been constructed into the PDCP PDU.

In an embodiment, the PDCP PDU in the first data packet set includes at least one of the following: the PDCP PDU in the first data packet set (the PSCP PDU corresponding to the PDCP SDU in the first data packet set), where the PDCP PDU has not been transmitted to the lower layer (namely, a protocol layer below PDCP, such as RLC, MAC, or a physical layer); and
the PDCP PDU in the first data packet set (the PSCP PDU corresponding to the PDCP SDU in the first data packet set), where the PDCP PDU has not been transmitted to the lower layer (namely, the protocol layer below PDCP, such as RLC, MAC, or the physical layer).

Optionally, the discarding a data packet in the first data packet set includes: discarding the data packet in the first data packet set in a case that a fourth condition is met.

The fourth condition includes at least one of the following:
the second information is obtained;
the first indication information is obtained;
that the first data packet set fails is determined;
the first data packet set does not meet at least one of the handling information with the data packet set as a whole, the criterion for the data packet set to succeed, and the criterion for using the data packet set; and
the first data packet set meets at least one of the criterion for the data packet set to fail, the criterion for being incapable of using the data packet set, and the criterion for discarding the data packet in the data packet set.

Optionally, the determining that a first data packet set succeeds includes:
in a case that a fifth condition is met, determining that the first data packet set succeeds.

The fifth condition includes at least one of the following:
the first data packet set meets at least one of the handling information with the data packet set as a whole, the criterion for the data packet set to succeed, and the criterion for using the data packet set.

Optionally, the determining that a first data packet set fails includes:
in a case that a sixth condition is met, determining that the first data packet set fails.

The sixth condition includes at least one of the following:
the first data packet set does not meet at least one of the handling information with the data packet set as a whole, the criterion for the data packet set to succeed, and the criterion for using the data packet set; and
the first data packet set meets at least one of the criterion for the data packet set to fail, the criterion for being incapable of using the data packet set, and the criterion for discarding the data packet in the data packet set.

Optionally, the sending the first indication information to a first communication device includes:
in a case that a seventh condition is met, sending the first indication information to the first communication device.

The seventh condition includes at least one of the following:
at least one of the second information and the first indication information is obtained from a core network device;
the first indication information is applicable to an uplink; and
handling of all data packet sets in a first object with the data packet set as a whole is inconsistent, where the first object includes at least one of the following: a data flow, a radio bearer, and a quality of service QoS flow.

Optionally, the sending first information to a first communication device includes:
in a case that an eighth condition is met, sending the first information to the first communication device.

The eighth condition includes at least one of the following:
at least one of the second information and the first indication information is obtained from the core network device;
the second information is applicable to the uplink;
the first indication information is applicable to the uplink; and
handling of all the data packet sets in the first object with the data packet set as a whole is consistent, or first information of all the data packet sets in the first object is consistent, where the first object includes at least one of the following: the data flow, the radio bearer, and the quality of service QoS flow.

In an embodiment, the radio bearer includes at least one of the following: a logical channel, and a DRB.

For example, the second communication device obtaining the second information, and the second communication device sending at least one of the first information and the first indication information to the first communication device according to at least one of the second information and the first indication information includes but is not limited to at least one of the following:
the second communication device obtaining the handling information with the data packet set as a whole, and sending at least one of the criterion for discarding the data packet in the data packet set and the first indication information to the first communication device according to the handling information with the data packet set as a whole;
the second communication device obtaining the handling information with the data packet set as a whole, and sending at least one of the handling information with the data packet set as a whole and the first indication information to the first communication device according to the handling information with the data packet set as a whole;
the second communication device obtaining the handling information with the data packet set as a whole, and sending at least one of the criterion for the data packet set to fail and the first indication information to the first communication device according to the handling information with the data packet set as a whole; and
the second communication device obtaining the handling information with the data packet set as a whole, and sending at least one of the criterion for the data packet set to fail, the criterion for discarding the data packet in the data packet set (such as discarding a failed data packet set), and the first indication information to the first communication device according to the handling information with the data packet set as a whole.

Optionally, the second communication device sending at least one of the first information and the first indication information to the first communication device according to at least one of the second information, the third information, and the first indication information includes:
the second communication device obtaining the handling information with the data packet set as a whole, and sending, to the first communication device according to the handling information with the data packet set as a whole, at least one of the criterion for discarding the data packet in the data packet set, the criterion for the data packet set to fail, and the first indication information.

Optionally, the second communication device obtaining the handling information with the data packet set as a whole, and sending, to the first communication device according to the handling information with the data packet set as a whole, at least one of the criterion for discarding the data packet in the data packet set, the criterion for the data packet set to fail, and the first indication information includes at least one of the following:
in a case that the handling information with the data packet set as a whole is used to indicate that data packets whose proportion is greater than or equal to a first proportion in the data packet set are needed to use the data packet set, the criterion for discarding the data packet in the data packet set is used to indicate that in a case that data packets whose proportion is greater than or equal to a fourth proportion in the data packet set fail, the data packet in the data packet set is discarded or the data packet set cannot be used, where a value of the fourth proportion is determined according to the first proportion;
in a case that the handling information with the data packet set as a whole is used to indicate that the data packets whose proportion is greater than or equal to the first proportion in the data packet set are needed to use the data packet set, the criterion for the data packet set to fail is used to indicate that in a case that data packets whose proportion is greater than or equal to a third proportion in the data packet set fail, it is determined that the data packet set fails, where a value of the third proportion is determined according to the first proportion;
in a case that the handling information with the data packet set as a whole is used to indicate that at least a 1st data packet in the data packet set is needed to use the data packet set, the criterion for discarding the data packet in the data packet set is used to indicate that in a case that the 1st data packet in the data packet set fails, the data packet in the data packet set is discarded or the data packet set cannot be used; and
in a case that the handling information with the data packet set as a whole is used to indicate that at least the 1st data packet in the data packet set is needed to use the data packet set, the criterion for the data packet set to fail is used to indicate that in a case that the 1st data packet in the data packet set fails, it is determined that the data packet set fails.

In an embodiment, the value of the third proportion being determined according to the first proportion includes: the value of the third proportion is a value obtained by subtracting the first proportion from 1.

In an embodiment, the value of the fourth proportion being determined according to the first proportion includes: the value of the fourth proportion is a value obtained by subtracting the first proportion from 1.

Optionally, in a case that the second information is obtained from the received data packet, the handling information with the data packet set as a whole is used to indicate at least one of the following:
all data packets in the data packet set are needed to use the data packet set;
the data packets whose proportion is greater than or equal to the first proportion in the data packet set are needed to use the data packet set; and
at least the 1st data packet in the data packet set is needed to use the data packet set.

In an embodiment, the first proportion is the same as the second proportion. In another embodiment, the first proportion is different from the second proportion.

In an embodiment, in a case that the handling information with the data packet set as a whole is “all data packets in the data packet set are needed to use the data packet set”, that the handling information with the data packet set as a whole is not met means that at least one data packet in the data packet set fails.

Optionally, the handling information with the data packet set as a whole or the criterion for using the data packet set is used to indicate at least one of the following:
the data packets whose proportion is greater than or equal to the first proportion in the data packet set are needed to use the data packet set; and
at least the 1st data packet in the data packet set is needed to use the data packet set.

In an embodiment, in a case that the second information is obtained from the fourth communication device, the handling information with the data packet set as a whole includes at least one of the following:
all data packets in the data packet set are needed to use the data packet set;
the data packets whose proportion is greater than or equal to the first proportion in the data packet set are needed to use the data packet set; and
at least the 1st data packet in the data packet set is needed to use the data packet set.

Optionally, that the first data packet set meets the handling information with the data packet set as a whole is used to indicate at least one of the following:
in a case that the handling information with the data packet set as a whole or the criterion for using the data packet set is used to indicate that the data packets whose proportion is greater than or equal to the first proportion in the data packet set are needed to use the data packet set, a proportion of successful data packets in the first data packet set is greater than or equal to the first proportion, or a proportion of failed data packets in the first data packet set is less than or equal to a value obtained by subtracting the first proportion from 1; and
in a case that the handling information with the data packet set as a whole or the criterion for using the data packet set is used to indicate that at least the 1st data packet in the data packet set is needed to use the data packet set, a 1st data packet in the first data packet set succeeds, or the 1st data packet in the first data packet set does not fail;
or
that the first data packet set does not meet the handling information with the data packet set as a whole includes at least one of the following:
in a case that the handling information with the data packet set as a whole or the criterion for using the data packet set is used to indicate that the data packets whose proportion is greater than or equal to the first proportion in the data packet set are needed to use the data packet set, a proportion of successful data packets in the first data packet set is less than or equal to the first proportion, or a proportion of failed data packets in the first data packet set is greater than or equal to a value obtained by subtracting the first proportion from 1; and
in a case that the handling information with the data packet set as a whole or the criterion for using the data packet set is used to indicate that at least the 1st data packet in the data packet set is needed to use the data packet set, a 1st data packet in the first data packet set fails.

In an embodiment, the proportion of successful data packets in the first data packet set is: a proportion of a quantity (or size) of successful data packets in the first data packet set to a quantity (or size) of all data packets in the first data packet set.

In an embodiment, the proportion of failed data packets in the first data packet set is: a proportion of a quantity (or size) of failed data packets in the first data packet set to a quantity (or size) of all data packets in the first data packet set.

Optionally, the criterion for using the data packet set is used to indicate at least one of the following:
the data packet set succeeds;
all the data packets in the data packet set succeed before the data packet set can be used;
the data packets whose proportion is greater than or equal to the first proportion in the data packet set succeed before the data packet set can be used;
data packets whose proportion is less than or equal to the third proportion in the data packet set fail before the data packet set can be used; and
at least the 1st data packet in the data packet set succeeds before the data packet set can be used;
or
the criterion for being incapable of using the data packet set is used to indicate at least one of the following:
the data packet set fails;
in a case that one or more data packets in the data packet set fail, the data packet set cannot be used;
in a case that data packets whose proportion is less than or equal to the first proportion in the data packet set succeed, the data packet set cannot be used;
in a case that data packets whose proportion is greater than or equal to the third proportion in the data packet set fail, the data packet set cannot be used; and
in a case that the 1st data packet in the data packet set fails, the data packet set cannot be used.

Optionally, the criterion for the data packet set to succeed is used to indicate at least one of the following:
in a case that a 1st data packet in the data packet set succeeds, determining that the data packet set succeeds;
in a case that data packets whose proportion is greater than or equal to a second proportion in the data packet set succeed, determining that the data packet set succeeds; and
in a case that all data packets in the data packet set succeed, determining that the data packet set succeeds.

In an embodiment, the first proportion is the same as the second proportion. In another embodiment, the first proportion is different from the second proportion.

In an embodiment, that the first data packet set meets the criterion for the data packet set to succeed is used to indicate at least one of the following:
in a case that the criterion for the data packet set to succeed is used to indicate that the data packet set is determined to be successful in a case that the 1st data packet in the data packet set succeeds, a 1st data packet in the first data packet set succeeds, or the 1st data packet in the first data packet set does not fail;
in a case that the criterion for the data packet set to succeed is used to indicate that the data packet set is determined to be successful in a case that data packets whose proportion is greater than or equal to the second proportion in the data packet set succeed, the proportion of successful data packets in the first data packet set is greater than or equal to the second proportion, or the proportion of failed data packets in the first data packet set is less than or equal to (the value obtained by subtracting the second proportion from 1); and
in a case that the criterion for the data packet set to succeed is used to indicate that the data packet set is determined to be successful in a case that all data packets in the data packet set succeed, all data packets in the first data packet set succeed, or a quantity of failed data packets in the first data packet set is 0.

In an embodiment, that the first data packet set does not meet the criterion for the data packet set to succeed is used to indicate at least one of the following:
in a case that the criterion for the data packet set to succeed is used to indicate that the data packet set is determined to be successful in a case that all data packets in the data packet set succeed, at least one data packet in the first data packet set fails;
in a case that the criterion for the data packet set to succeed is used to indicate that the data packet set is determined to be successful in a case that data packets whose proportion is greater than or equal to the second proportion in the data packet set succeed, data packets whose proportion is greater than or equal to (the value obtained by subtracting the second proportion from 1) in the first data packet set fail, or data packets whose proportion is less than or equal to the second proportion in the first data packet set succeed; and
in a case that the criterion for the data packet set to succeed is used to indicate that the data packet set is determined to be successful in a case that the 1st data packet in the data packet set succeeds, the 1st data packet in the first data packet set fails.

Optionally, the criterion for the data packet set to fail is used to indicate at least one of the following:
in a case that one or more data packets in the data packet set fail, determining that the data packet set fails;
in a case that data packets whose proportion is greater than or equal to a third proportion in the data packet set fail, determining that the data packet set fails; and in a case that at least a 1st data packet in the data packet set fails, determining that the data packet set fails.

In an embodiment, the value of the third proportion is equal to the value obtained by subtracting the first proportion from 1, or the value obtained by subtracting the second proportion from 1.

In an embodiment, that the first data packet set meets the criterion for the data packet set to fail is used to indicate at least one of the following:
in a case that the criterion for the data packet set to fail is used to indicate that the data packet set is determined to be failed in a case that one or more data packets in the data packet set fail, one or more data packets in the first data packet set fail;
in a case that the criterion for the data packet set to fail is used to indicate that the data packet set is determined to be failed in a case that data packets whose proportion is greater than or equal to the third proportion in the data packet set fail, data packets whose proportion is greater than or equal to the third proportion in the first data packet set fail, or data packets whose proportion is less than or equal to (the value obtained by subtracting the third proportion from 1) in the first data packet set succeed; and
in a case that the criterion for the data packet set to fail is used to indicate that the data packet set is determined to be failed in a case that the 1st data packet in the data packet set fails, the 1st data packet in the first data packet set fails.

Optionally, the criterion for discarding the data packet in the data packet set is used to indicate at least one of the following:
in a case that one or more data packets in the data packet set fail, the data packet in the data packet set is discarded or the data packet set cannot be used;
in a case that a 1st data packet in the data packet set fails, the data packet in the data packet set is discarded or the data packet set cannot be used; and
in a case that data packets whose proportion is greater than or equal to a fourth proportion in the data packet set fail, the data packet in the data packet set is discarded or the data packet set cannot be used.

In an embodiment, the value of the fourth proportion is equal to the value obtained by subtracting the first proportion from 1, or the value obtained by subtracting the second proportion from 1.

In an embodiment, the third proportion is the same as the fourth proportion. In another embodiment, the third proportion is different from the fourth proportion.

In an embodiment, the failed data packet includes at least one of the following: a data packet that fails to be sent; a data packet that fails to be received; a data packet that fails to be transmitted; a data packet for which no receiving acknowledgment is received after the data packet is sent; one of the following present in a case that a Discard timer expires: the data packet, and a PDCP SDU or a PDCP PDU corresponding to the data packet; and a PDCP SDU or a PSCP PDU in a case that the Discard timer expires;
or
that the data packet fails includes at least one of the following:
the data packet fails to be sent;
the data packet fails to be received;
the data packet fails to be transmitted;
no receiving acknowledgment is received after the data packet is sent; and
the data packet fails when the data packet or the PDCP SDU or the PDCP PDU corresponding to the data packet is present in a case that the Discard timer expires.

According to this embodiment of this application, the second communication device obtains at least one of the second information, the third information, and the first indication information. Based on at least one of the second information, the third information, and the first indication information, the second communication device can determine that the first data packet set succeeds or fails, or discard the data packet in the first data packet set, thereby avoiding transmission of unnecessary data packets, saving network resources, and effectively alleviating pressure on network resources.

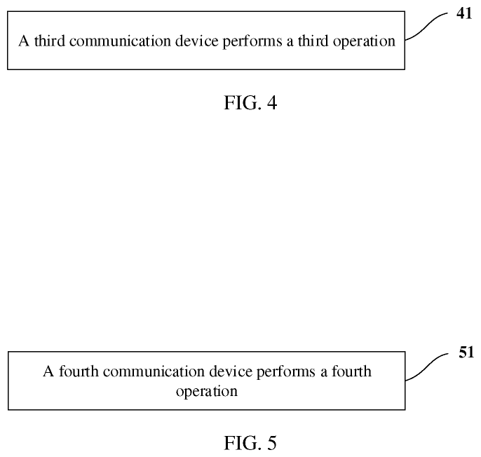

Referring to FIG. 4, an embodiment of this application provides an information handling method, applied to a third communication device. The third communication device includes but is not limited to one of the following: a core network device (such as a gateway, a UPF (such as a PSA UPF)). The method includes the following step:

Step 41: The third communication device performs a third operation, where the third operation includes at least one of the following:
detecting second information of a first data packet set;
setting a packet header of a first data packet to include the second information of the first data packet set, where the first data packet is a data packet in the first data packet set; and
sending the first data packet set, where a packet header of the first data packet set includes the second information, and
the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set.

Optionally, the third communication device performing the third operation includes:
the third communication device receiving fourth information; and
the third communication device performing the third operation according to the fourth information.

The fourth information includes at least one of the following:
protocol description information, where the protocol description information is used for at least one of the following: describing a protocol used for a service flow, and indicating that the protocol described by the protocol description information can provide information used to determine the second information of the first data packet set; and
second indication information or third indication information.

The second indication information is used to indicate at least one of the following:
detecting second information of the data packet set; and
setting a packet header of a data packet to include the second information of the data packet set, where the data packet is a data packet in the data packet set, where
the third indication information is used to indicate at least one of the following:
detecting data packet set information corresponding to the data packet; and
setting the packet header of the data packet to include the data packet set information corresponding to the data packet.

In an implementation, the third communication device receives the second information from a fourth communication device.

In an embodiment, the third indication information is a PDU set information mark indication.

In an embodiment, the protocol includes but is not limited to at least one of the following: RTP, SRTP, MPEG, and the like.

In an embodiment, the data packet set information (such as PDU set information) includes the second information. In another embodiment, the data packet set information (such as PDU set information) does not include the second information.

In an embodiment, the packet header is a GPRS Tunneling Protocol-User Plane (GTP-U) packet header or a GTP-U extended packet header.

Optionally, setting the packet header of the data packet to include the data packet set information (such as the PDU set information) corresponding to the data packet is: setting a value of the data packet set information (such as the PDU set information) corresponding to the data packet at a bit of the data packet set (such as the PDU set information) corresponding to the packet header (such as the GTP-U packet header) of the data packet.

Optionally, the data packet set information (such as the PDU set information) corresponding to the data packet is data packet set information (such as PDU set information) of a data packet set (such as a PDU set) to which the data packet belongs.

In an embodiment, it is determined, through traffic detection, whether information for determining the data packet set information (PDU information (such as PDU set importance and a PDU set size)) is carried in a packet header of a protocol used for a service flow of the data packet. The protocol is a protocol indicated by the protocol description information.

Optionally, the handling information with the data packet set as a whole or the criterion for using the data packet set is used to indicate at least one of the following:
all data packets in the data packet set are needed to use the data packet set;
data packets whose proportion is greater than or equal to a first proportion in the data packet set are needed to use the data packet set; and
at least a 1st data packet in the data packet set is needed to use the data packet set.

In an embodiment, in a case that the handling information with the data packet set as a whole is “all data packets in the data packet set are needed to use the data packet set”, that the handling information with the data packet set as a whole is not met means that at least one data packet in the data packet set fails.

Optionally, the criterion for using the data packet set is used to indicate at least one of the following:
the data packet set succeeds;
all the data packets in the data packet set succeed before the data packet set can be used;
the data packets whose proportion is greater than or equal to the first proportion in the data packet set succeed before the data packet set can be used;
data packets whose proportion is less than or equal to a third proportion in the data packet set fail before the data packet set can be used; and
at least the 1st data packet in the data packet set succeeds before the data packet set can be used;
or
the criterion for being incapable of using the data packet set is used to indicate at least one of the following:
the data packet set fails;
in a case that one or more data packets in the data packet set fail, the data packet set cannot be used;
in a case that data packets whose proportion is less than or equal to the first proportion in the data packet set succeed, the data packet set cannot be used;
in a case that data packets whose proportion is greater than or equal to a third proportion in the data packet set fail, the data packet set cannot be used; and
in a case that the 1st data packet in the data packet set fails, the data packet set cannot be used.

Optionally, the criterion for the data packet set to succeed is used to indicate at least one of the following:
in a case that the 1st data packet in the data packet set succeeds, determining that the data packet set succeeds;
in a case that data packets whose proportion is greater than or equal to a second proportion in the data packet set succeed, determining that the data packet set succeeds; and
in a case that all the data packets in the data packet set succeed, determining that the data packet set succeeds.

Optionally, the criterion for the data packet set to fail is used to indicate at least one of the following:
in a case that the one or more data packets in the data packet set fail, determining that the data packet set fails;
in a case that the data packets whose proportion is greater than or equal to the third proportion in the data packet set fail, determining that the data packet set fails; and
in a case that at least the 1st data packet in the data packet set fails, determining that the data packet set fails.

Optionally, the criterion for discarding the data packet in the data packet set is used to indicate at least one of the following:
in a case that the one or more data packets in the data packet set fail, the data packet in the data packet set is discarded or the data packet set cannot be used;
in a case that the 1st data packet in the data packet set fails, the data packet in the data packet set is discarded or the data packet set cannot be used; and
in a case that data packets whose proportion is greater than or equal to a fourth proportion in the data packet set fail, the data packet in the data packet set is discarded or the data packet set cannot be used.

In an embodiment, the value of the fourth proportion is equal to the value obtained by subtracting the first proportion from 1, or the value obtained by subtracting the second proportion from 1.

Optionally, the first information, the handling information with the data packet set as a whole, the criterion for using the data packet set, or the criterion for the data packet set to succeed may be PDU set integrated handling information (PDU Set Integrated Handling Information, PSIHI).

According to this embodiment of this application, the third communication device detects the second information of the first data packet set; sets the packet header of the first data packet to include the second information of the first data packet set; or sends the first data packet set, where the packet header of the first data packet set includes the second information, so that the second communication device can determine that the first data packet set succeeds or fails, or discards the data packet in the first data packet set, thereby avoiding transmission of unnecessary data packets, saving network resources, and effectively alleviating pressure on network resources.

Referring to FIG. 5, an embodiment of this application provides an information handling method, applied to a fourth communication device. The fourth communication device includes but is not limited to a core network device (such as an SMF, a PCF, or an AF). The method includes the following step:

Step 51: The fourth communication device performs a fourth operation, where the fourth operation includes at least one of the following:
sending at least one of first information and first indication information to a first communication device;
sending at least one of second information and the first indication information to a second communication device;
sending fourth information to a third communication device; and
obtaining third information, where the third information is used to indicate one of the following information: inconsistent handling of all data packet sets with the data packet set as a whole, and consistent handling of all data packet sets with the data packet set as a whole.

The first information or the second information is used to indicate at least one of the following:
handling information with the data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set.

The first indication information is used to indicate at least one of the following: performing packet discarding according to the first information; discarding a data packet in a failed data packet set; and discarding the data packet in the data packet set.

The fourth information includes at least one of the following:
protocol description information, where the protocol description information is used for at least one of the following: describing a protocol used for a service flow, and indicating that the protocol described by the protocol description information can provide information used to determine second information of a first data packet set; and
second indication information or third indication information.

The second indication information is used to indicate at least one of the following:
detecting second information of the data packet set; and
setting a packet header of a data packet to include the second information of the data packet set, where the data packet is a data packet in the data packet set.

The third indication information is used to indicate at least one of the following:
detecting data packet set information corresponding to the data packet; and
setting the packet header of the data packet to include the data packet set information corresponding to the data packet.

Optionally, the sending the first indication information to a first communication device includes:
in a case that a ninth condition is met, sending the first indication information to the first communication device.

The ninth condition includes at least one of the following:
the first indication information is applicable to an uplink; and
handling of all data packet sets in a first object with the data packet set as a whole is inconsistent, where the first object includes at least one of the following: a data flow, a radio bearer, and a quality of service QoS flow.

Optionally, the sending first information to a first communication device includes:
in a case that a tenth condition is met, sending the first information to the first communication device.

The tenth condition includes at least one of the following:
the first information is applicable to an uplink;
the first indication information is applicable to the uplink; and
handling of all data packet sets in a first object with the data packet set as a whole is consistent, or first information of all the data packet sets in the first object is consistent, where the first object includes at least one of the following: a data flow, a radio bearer, and a quality of service QoS flow.

Optionally, the sending at least one of second information and the first indication information to a second communication device includes:
in a case that an eleventh condition is met, sending at least one of the second information and the first indication information to the second communication device.

The eleventh condition includes at least one of the following:
the second information is applicable to a downlink;
the first indication information is applicable to the downlink; and
handling of all data packet sets in a first object with the data packet set as a whole is consistent, or first information of all the data packet sets in the first object is consistent, where the first object includes at least one of the following: a data flow, a radio bearer, and a quality of service QoS flow.

Optionally, the fourth communication device performing the fourth operation includes:
the fourth communication device obtaining at least one of the second information, the third information, and the first indication information; and
the fourth communication device performing the fourth operation according to at least one of the second information, the third information, and the first indication information.

In an embodiment, the fourth communication device may obtain at least one of the second information, the third information, and the first indication information from the AF, a NEF, the SMF, the PCF, or the first communication device.

In an embodiment, when the fourth communication device is an SMF, the fourth communication device may obtain at least one of the second information, the third information, and the first indication information from the AF, the NEF, the PCF, or the first communication device.

In an embodiment, when the fourth communication device is a PCF, the fourth communication device may obtain at least one of the second information, the third information, and the first indication information from the AF, the NEF, or the SMF.

According to this embodiment of this application, the fourth communication device sends at least one of the first information and the first indication information to the first communication device or the second communication device, or the fourth communication device sends the fourth information to the third communication device, so that the third communication device detects the second information of the first data packet set based on the second information; sets the packet header of the first data packet to include the second information of the first data packet set; or sends the first data packet set. Therefore, the first communication device or the second communication device can determine that the first data packet set succeeds or fails, or discard the data packet in the first data packet set, thereby avoiding transmission of unnecessary data packets, saving network resources, and effectively alleviating pressure on network resources.

The following describes the information handling method in the embodiments of this application with reference to specific application scenarios.

### Embodiment 1 of this Application

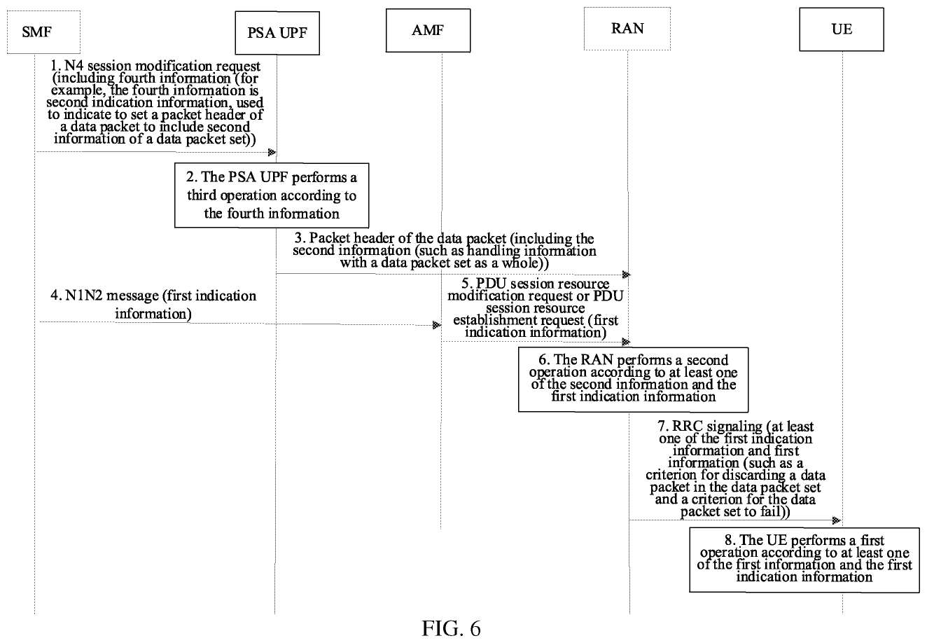

As shown in FIG. 6, Embodiment 1 of this application includes the following steps:

Step 1: An SMF sends an N4 session modification request to a PSA UPF. Optionally, the N4 session modification request includes fourth information, for example, the fourth information is second indication information, and the second indication information is used to indicate to set a packet header of a data packet to include second information of a data packet set.

Step 2: The PSA UPF performs a third operation according to the fourth information.

For example, the PSA UPF sets the packet header of the data packet to include the second information according to the fourth information, and the second information may be handling information with the data packet set as a whole.

Step 3: The PSA UPF sends a data packet to a RAN, where a packet header of the data packet includes the second information.

Step 4: The SMF sends an N1N2 message to an AMF. Optionally, the N1N2 message includes first indication information.

Step 4 and Step 1 may be interchanged in term of the sequence, or Step 1 and Step 4 may be initiated simultaneously.

Step 5: The AMF sends a PDU session resource modification request or a PDU session resource establishment request to the RAN. Optionally, the PDU session resource modification request or the PDU session resource establishment request includes the first indication information.

Step 6: The RAN performs a second operation according to at least one of the second information and the first indication information, as described in the embodiment of the second communication device.

Step 7: Optionally, the RAN sends RRC signaling to UE, where the RRC signaling includes first information, for example, the first information includes at least one of a criterion for discarding a data packet in the data packet set, a criterion for the data packet set to fail, and the first indication information.

Step 8: The UE performs a first operation according to at least one of the first information and the first indication information, as described in the embodiment of the first communication device.

### Embodiment 2 of this Application

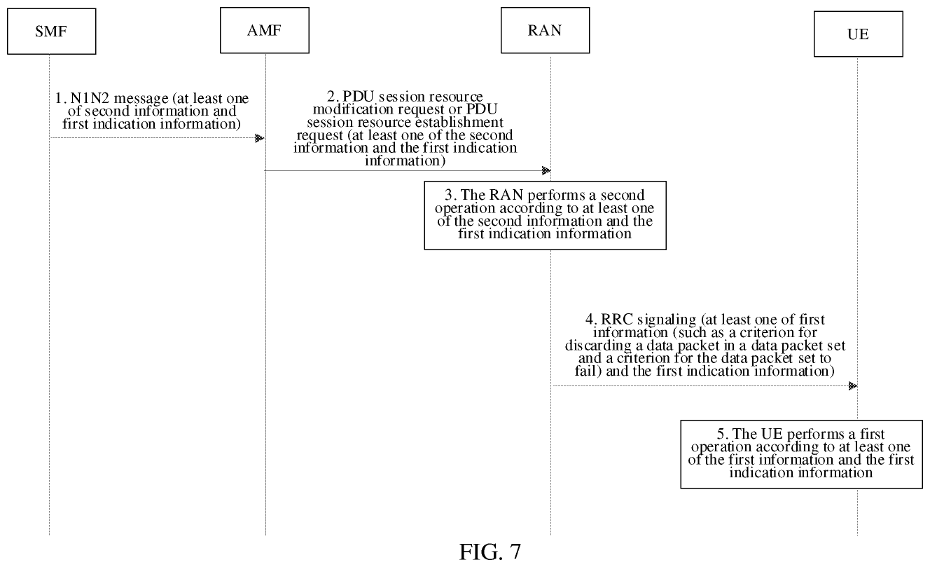

As shown in FIG. 7, Embodiment 2 of this application includes the following steps:

Step 1: An SMF sends an N1N2 message to an AMF. Optionally, the N1N2 message includes at least one of first indication information and second information.

Step 2: The AMF sends a PDU session resource modification request or a PDU session resource establishment request to a RAN. Optionally, the PDU session resource modification request or the PDU session resource establishment request includes at least one of the first indication information and the second information.

Step 3: The RAN performs a second operation according to at least one of the second information and the first indication information, as described in the embodiment of the second communication device.

Step 4: Optionally, the RAN sends RRC signaling to UE, where the RRC signaling includes at least one of first information and the first indication information. The first information includes, for example, at least one of a criterion for discarding a data packet in a data packet set and a criterion for the data packet set to fail.

Step 5: The UE performs a first operation according to at least one of the first information and the first indication information, as described in the embodiment of the first communication device.

### Embodiment 3 of This Application

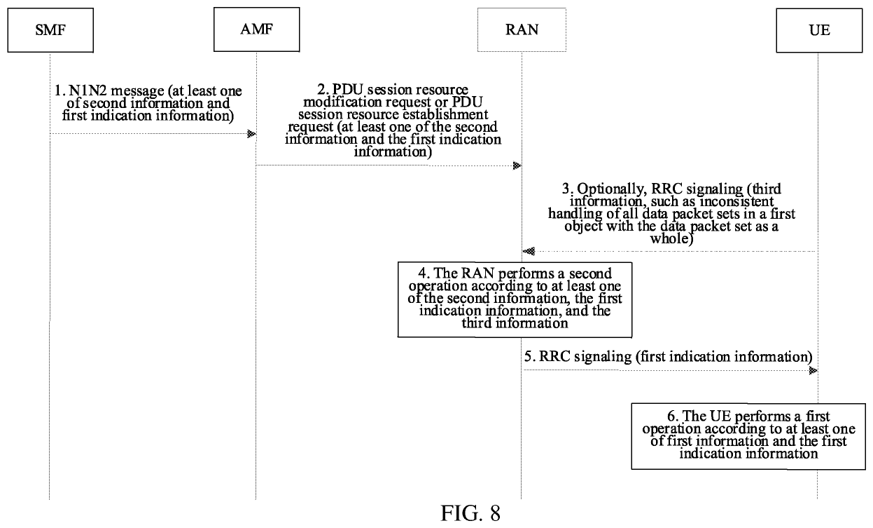

As shown in FIG. 8, Embodiment 3 of this application includes the following steps:

Step 1: An SMF sends an N1N2 message to an AMF. Optionally, the N1N2 message includes at least one of first indication information and second information.

Step 2: The AMF sends a PDU session resource modification request or a PDU session resource establishment request to a RAN. Optionally, the PDU session resource modification request or the PDU session resource establishment request includes at least one of the first indication information and the second information.

Step 3: The UE sends RRC signaling to the RAN. Optionally, the RRC signaling includes third information. For example, the third information is used to indicate inconsistent handling of all data packet sets with the data packet set as a whole.

Step 4: The RAN performs a second operation according to at least one of the second information, the first indication information, and the third information, as described in the embodiment of the second communication device.

Step 5: Optionally, the RAN sends the first indication information to the UE.

Step 6: The UE performs a first operation according to at least one of the first indication information and first information, as described in the embodiment of the first communication device.

### Embodiment 4 of This Application

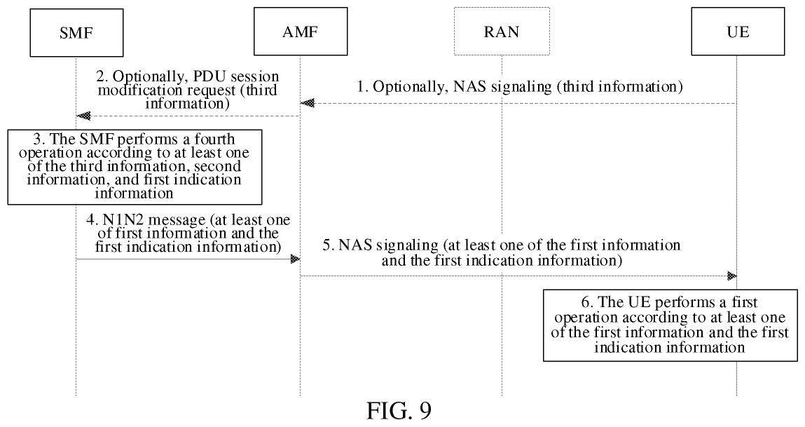

As shown in FIG. 9, Embodiment 4 of this application includes the following steps:

Step 1 (optional): Optionally, UE sends NAS signaling to an AMF. Optionally, the NAS signaling includes third information.

Step 2 (optional): Optionally, the AMF sends a PDU session modification request to an SMF, where the PDU session modification request includes third information.

Step 3: The SMF performs a fourth operation according to at least one of the third information, second information, and first indication information, as described in the embodiment of the fourth communication device.

Step 4: The SMF sends an N1N2 message to the AMF, where the N1N2 message includes at least one of first information and the first indication information.

Step 5: The AMF sends NAS signaling to the UE, where the NAS signaling includes at least one of the first information and the first indication information.

Step 6: The UE performs a first operation according to at least one of the first information and the first indication information, as described in the embodiment of the first communication device.

The information handling method provided in the embodiments of this application may be performed by an information handling apparatus. In the embodiments of this application, an example in which the information handling apparatus performs the information handling method is used to describe the information handling apparatus provided in the embodiments of this application.

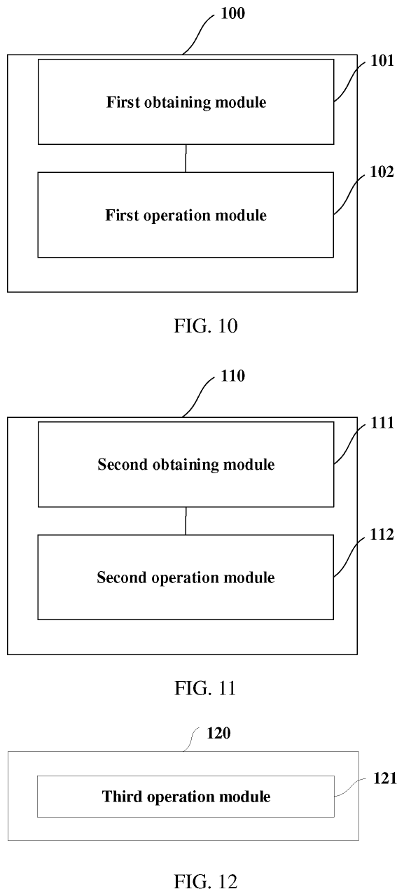

Referring to FIG. 10, an embodiment of this application further provides an information handling apparatus 100, including:
a first obtaining module 101, configured to obtain at least one of first information and first indication information; and
a first operation module 102, configured to perform a first operation according to at least one of the first information and the first indication information, where
the first information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set, where
the first operation includes at least one of the following:
determining that a first data packet set succeeds or fails;
discarding a data packet in the first data packet set; and
handling data with the data packet set as a whole, where
the first indication information is used to indicate at least one of the following: performing packet discarding according to the first information; discarding a data packet in a failed data packet set; and discarding the data packet in the data packet set.

Optionally, the first obtaining module is configured to:
receive the first information sent by a second communication device or a fourth communication device;
or
obtain the first information through local configuration or self-learning;
or
obtain, by an access stratum AS of the first communication device, the first information via a higher layer of the first communication device.

Optionally, the first obtaining module is configured to:
receive the first indication information sent by the second communication device or the fourth communication device;
or
obtain, by the access stratum AS of the first communication device, the first indication information from a non-access stratum NAS or an application layer of the first communication device.

Optionally, the discarding a data packet in the first data packet set includes discarding at least one of the following: all data packets in the first data packet set, a remaining data packet in the first data packet set, a data packet in the first data packet set in a cache, an untransmitted data packet in the first data packet set, an unsuccessfully transmitted data packet in the first data packet set, a failed data packet in the first data packet set, a packet data convergence protocol service data unit PDCP SDU in the first data packet set, and a PDCP protocol data unit PDU in the first data packet set.

Optionally, the first operation module is configured to discard the data packet in the first data packet set in a case that a first condition is met, where
the first condition includes at least one of the following:
the first information is obtained;
the first indication information is obtained;
that the first data packet set fails is determined;
the first data packet set does not meet at least one of the handling information with the data packet set as a whole, the criterion for the data packet set to succeed, and the criterion for using the data packet set; and
the first data packet set meets at least one of the criterion for the data packet set to fail, the criterion for being incapable of using the data packet set, and the criterion for discarding the data packet in the data packet set.

Optionally, the first operation module is configured to:
in a case that a second condition is met, determine that the first data packet set succeeds, where
the second condition includes at least one of the following:
the first data packet set meets at least one of the handling information with the data packet set as a whole, the criterion for the data packet set to succeed, and the criterion for using the data packet set.

Optionally, the first operation module is configured to:
in a case that a third condition is met, determine that the first data packet set fails, where
the third condition includes at least one of the following:
the first data packet set does not meet at least one of the handling information with the data packet set as a whole, the criterion for the data packet set to succeed, and the criterion for using the data packet set; and
the first data packet set meets at least one of the criterion for the data packet set to fail, the criterion for being incapable of using the data packet set, and the criterion for discarding the data packet in the data packet set.

Optionally, the handling information with the data packet set as a whole or the criterion for using the data packet set is used to indicate at least one of the following:
all data packets in the data packet set are needed to use the data packet set;
data packets whose proportion is greater than or equal to a first proportion in the data packet set are needed to use the data packet set; and
at least a 1st data packet in the data packet set is needed to use the data packet set.

Optionally, that the first data packet set meets the handling information with the data packet set as a whole is used to indicate at least one of the following:
in a case that the handling information with the data packet set as a whole or the criterion for using the data packet set is used to indicate that the data packets whose proportion is greater than or equal to the first proportion in the data packet set are needed to use the data packet set, a proportion of successful data packets in the first data packet set is greater than or equal to the first proportion, or a proportion of failed data packets in the first data packet set is less than or equal to a value obtained by subtracting the first proportion from 1; and
in a case that the handling information with the data packet set as a whole or the criterion for using the data packet set is used to indicate that at least the 1st data packet in the data packet set is needed to use the data packet set, a 1st data packet in the first data packet set succeeds, or the 1st data packet in the first data packet set does not fail;
or
that the first data packet set does not meet the handling information with the data packet set as a whole includes at least one of the following:
in a case that the handling information with the data packet set as a whole or the criterion for using the data packet set is used to indicate that the data packets whose proportion is greater than or equal to the first proportion in the data packet set are needed to use the data packet set, a proportion of successful data packets in the first data packet set is less than or equal to the first proportion, or a proportion of failed data packets in the first data packet set is greater than or equal to a value obtained by subtracting the first proportion from 1; and
in a case that the handling information with the data packet set as a whole or the criterion for using the data packet set is used to indicate that at least the 1st data packet in the data packet set is needed to use the data packet set, a 1st data packet in the first data packet set fails.

Optionally, the criterion for using the data packet set is used to indicate at least one of the following:
the data packet set succeeds;
all the data packets in the data packet set succeed before the data packet set can be used;
the data packets whose proportion is greater than or equal to the first proportion in the data packet set succeed before the data packet set can be used;
data packets whose proportion is less than or equal to a third proportion in the data packet set fail before the data packet set can be used; and
at least the 1st data packet in the data packet set succeeds before the data packet set can be used;
or
the criterion for being incapable of using the data packet set is used to indicate at least one of the following:
the data packet set fails;
in a case that one or more data packets in the data packet set fail, the data packet set cannot be used;
in a case that data packets whose proportion is less than or equal to the first proportion in the data packet set succeed, the data packet set cannot be used;
in a case that data packets whose proportion is greater than or equal to a third proportion in the data packet set fail, the data packet set cannot be used; and
in a case that the 1st data packet in the data packet set fails, the data packet set cannot be used.

Optionally, the criterion for the data packet set to succeed is used to indicate at least one of the following:
in a case that a 1st data packet in the data packet set succeeds, determining that the data packet set succeeds;
in a case that data packets whose proportion is greater than or equal to a second proportion in the data packet set succeed, determining that the data packet set succeeds; and
in a case that all data packets in the data packet set succeed, determining that the data packet set succeeds.

Optionally, the criterion for the data packet set to fail is used to indicate at least one of the following:
in a case that one or more data packets in the data packet set fail, determining that the data packet set fails;
in a case that data packets whose proportion is greater than or equal to a third proportion in the data packet set fail, determining that the data packet set fails; and
in a case that a 1st data packet in the data packet set fails, determining that the data packet set fails.

Optionally, the criterion for discarding the data packet in the data packet set is used to indicate at least one of the following:
in a case that one or more data packets in the data packet set fail, the data packet in the data packet set is discarded or the data packet set cannot be used;
in a case that a 1st data packet in the data packet set fails, the data packet in the data packet set is discarded or the data packet set cannot be used; and
in a case that data packets whose proportion is greater than or equal to a fourth proportion in the data packet set fail, the data packet in the data packet set is discarded or the data packet set cannot be used.

Optionally, the failed data packet includes at least one of the following: a data packet that fails to be sent; a data packet that fails to be received; a data packet that fails to be transmitted; a data packet for which no receiving acknowledgment is received after the data packet is sent; one of the following present in a case that a Discard timer expires: the data packet, and a PDCP SDU or a PDCP PDU corresponding to the data packet; and a PDCP SDU or a PSCP PDU in a case that the Discard timer expires;
or
that the data packet fails includes at least one of the following:
the data packet fails to be sent;
the data packet fails to be received;
the data packet fails to be transmitted;
no receiving acknowledgment is received after the data packet is sent; and
the data packet fails when the data packet or the PDCP SDU or the PDCP PDU corresponding to the data packet is present in a case that the Discard timer expires.

Optionally, the apparatus in this embodiment of this application further includes:
a first sending module, configured to send third information to the second communication device or the fourth communication device before the first operation module performs the first operation according to at least one of the first information and the first indication information, where the third information is used to indicate one of the following: inconsistent handling of all data packet sets with the data packet set as a whole, and consistent handling of all data packet sets with the data packet set as a whole.

According to this embodiment of this application, the first communication device obtains at least one of the first information and the first indication information. Based on at least one of the first information and the first indication information, the first communication device can determine that the first data packet set succeeds or fails, or discard the data packet in the first data packet set, thereby avoiding transmission of unnecessary data packets, saving network resources, and effectively alleviating pressure on network resources.

The information handling apparatus provided in this embodiment of this application can implement the processes implemented in the method embodiment of FIG. 2, and achieve same technical effects. To avoid repetition, details are not described herein again.

The information handling apparatus in this embodiment of this application may be an electronic device, for example, an electronic device with an operating system, or may be a component, for example, an integrated circuit or a chip, in an electronic device. The electronic device may be a terminal, or may be another device different from a terminal. For example, the terminal may include but is not limited to the foregoing listed types of the terminal 11. The another device may be a server, a network attached storage (Network Attached Storage, NAS), or the like. This is not specifically limited in this embodiment of this application.

The information handling apparatus provided in this embodiment of this application can implement the processes implemented in the method embodiment of FIG. 3, and achieve same technical effects. To avoid repetition, details are not described herein again.

Referring to FIG. 11, an embodiment of this application further provides an information handling apparatus 110, including:
a second obtaining module 111, configured to obtain at least one of second information, third information, and first indication information; and
a second operation module 112, configured to perform a second operation according to at least one of the second information, the third information, and the first indication information, where
the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set, where
the second operation includes at least one of the following:
determining that a first data packet set succeeds or fails;
discarding a data packet in the first data packet set;
sending at least one of first information and the first indication information to a first communication device; and
handling data with the data packet set as a whole, where
the first information is used to indicate at least one of the following:
the handling information with the data packet set as a whole;
the criterion for using the data packet set, or the criterion for being incapable of using the data packet set;
the criterion for the data packet set to succeed, or the criterion for the data packet set to fail; and
the criterion for discarding the data packet in the data packet set, where
the first indication information is used to indicate at least one of the following: performing packet discarding according to the first information; discarding a data packet in a failed data packet set; and discarding the data packet in the data packet set; and
the third information is used to indicate one of the following information: inconsistent handling of all data packet sets with the data packet set as a whole, and consistent handling of all data packet sets with the data packet set as a whole.

Optionally, the first data packet set is a data packet set in a downlink direction, or the data packet in the first data packet set is a downlink data packet.

Optionally, the second obtaining module is configured to receive the second information sent by a fourth communication device; or
obtain the second information from a received data packet.

Optionally, the second obtaining module is configured to:
receive the third information sent by at least one of the first communication device and a fourth communication device.

Optionally, the discarding a data packet in the first data packet set includes discarding at least one of the following: all data packets in the first data packet set, a remaining data packet in the first data packet set, a data packet in the first data packet set in a cache, an untransmitted data packet in the first data packet set, an unsuccessfully transmitted data packet in the first data packet set, a failed data packet in the first data packet set, a PDCP SDU in the first data packet set, and a PDCP PDU in the first data packet set.

Optionally, the second operation module is configured to discard the data packet in the first data packet set in a case that a fourth condition is met, where
the fourth condition includes at least one of the following:
the second information is obtained;
the first indication information is obtained;
that the first data packet set fails is determined;
the first data packet set does not meet at least one of the handling information with the data packet set as a whole, the criterion for the data packet set to succeed, and the criterion for using the data packet set; and
the first data packet set meets at least one of the criterion for the data packet set to fail, the criterion for being incapable of using the data packet set, and the criterion for discarding the data packet in the data packet set.

Optionally, the second operation module is configured to:
in a case that a fifth condition is met, determine that the first data packet set succeeds, where
the fifth condition includes at least one of the following:
the first data packet set meets at least one of the handling information with the data packet set as a whole, the criterion for the data packet set to succeed, and the criterion for using the data packet set.

Optionally, the second operation module is configured to:
in a case that a sixth condition is met, determine that the first data packet set fails, where
the sixth condition includes at least one of the following:
the first data packet set does not meet at least one of the handling information with the data packet set as a whole, the criterion for the data packet set to succeed, and the criterion for using the data packet set; and
the first data packet set meets at least one of the criterion for the data packet set to fail, the criterion for being incapable of using the data packet set, and the criterion for discarding the data packet in the data packet set.

Optionally, the second operation module is configured to:
in a case that a seventh condition is met, send the first indication information to the first communication device, where
the seventh condition includes at least one of the following:
at least one of the second information and the first indication information is obtained from a core network device;
the first indication information is applicable to an uplink; and
handling of all data packet sets in a first object with the data packet set as a whole is inconsistent, where the first object includes at least one of the following: a data flow, a radio bearer, and a quality of service QoS flow.

Optionally, the second operation module is configured to: in a case that an eighth condition is met, send the first information to the first communication device, where
the eighth condition includes at least one of the following:
at least one of the second information and the first indication information is obtained from the core network device;
the second information is applicable to the uplink;
the first indication information is applicable to the uplink; and
handling of all the data packet sets in the first object with the data packet set as a whole is consistent, or first information of all the data packet sets in the first object is consistent, where the first object includes at least one of the following: the data flow, the radio bearer, and the quality of service QoS flow.

Optionally, the second operation module is configured to:
obtain the handling information with the data packet set as a whole, and send, to the first communication device according to the handling information with the data packet set as a whole, at least one of the criterion for discarding the data packet in the data packet set, the criterion for the data packet set to fail, and the first indication information.

Optionally, the second operation module is configured to perform at least one of the following:
in a case that the handling information with the data packet set as a whole is used to indicate that data packets whose proportion is greater than or equal to a first proportion in the data packet set are needed to use the data packet set, the criterion for discarding the data packet in the data packet set is used to indicate that in a case that data packets whose proportion is greater than or equal to a fourth proportion in the data packet set fail, the data packet in the data packet set is discarded or the data packet set cannot be used, where a value of the fourth proportion is determined according to the first proportion;
in a case that the handling information with the data packet set as a whole is used to indicate that the data packets whose proportion is greater than or equal to the first proportion in the data packet set are needed to use the data packet set, the criterion for the data packet set to fail is used to indicate that in a case that data packets whose proportion is greater than or equal to a third proportion in the data packet set fail, it is determined that the data packet set fails, where a value of the third proportion is determined according to the first proportion;
in a case that the handling information with the data packet set as a whole is used to indicate that at least a 1st data packet in the data packet set is needed to use the data packet set, the criterion for discarding the data packet in the data packet set is used to indicate that in a case that the 1st data packet in the data packet set fails, the data packet in the data packet set is discarded or the data packet set cannot be used; and
in a case that the handling information with the data packet set as a whole is used to indicate that at least the 1st data packet in the data packet set is needed to use the data packet set, the criterion for the data packet set to fail is used to indicate that in a case that the 1st data packet in the data packet set fails, it is determined that the data packet set fails.

Optionally, in a case that the second information is obtained from the received data packet, the handling information with the data packet set as a whole is used to indicate at least one of the following:
all data packets in the data packet set are needed to use the data packet set;
the data packets whose proportion is greater than or equal to the first proportion in the data packet set are needed to use the data packet set; and
at least the 1st data packet in the data packet set is needed to use the data packet set.

Optionally, the handling information with the data packet set as a whole or the criterion for using the data packet set is used to indicate at least one of the following:
the data packets whose proportion is greater than or equal to the first proportion in the data packet set are needed to use the data packet set; and
at least the 1st data packet in the data packet set is needed to use the data packet set.

Optionally, that the first data packet set meets the handling information with the data packet set as a whole is used to indicate at least one of the following:
in a case that the handling information with the data packet set as a whole or the criterion for using the data packet set is used to indicate that the data packets whose proportion is greater than or equal to the first proportion in the data packet set are needed to use the data packet set, a proportion of successful data packets in the first data packet set is greater than or equal to the first proportion, or a proportion of failed data packets in the first data packet set is less than or equal to a value obtained by subtracting the first proportion from 1; and
in a case that the handling information with the data packet set as a whole or the criterion for using the data packet set is used to indicate that at least the 1st data packet in the data packet set is needed to use the data packet set, a 1st data packet in the first data packet set succeeds, or the 1st data packet in the first data packet set does not fail;
or
that the first data packet set does not meet the handling information with the data packet set as a whole includes at least one of the following:
in a case that the handling information with the data packet set as a whole or the criterion for using the data packet set is used to indicate that the data packets whose proportion is greater than or equal to the first proportion in the data packet set are needed to use the data packet set, a proportion of successful data packets in the first data packet set is less than or equal to the first proportion, or a proportion of failed data packets in the first data packet set is greater than or equal to a value obtained by subtracting the first proportion from 1; and
in a case that the handling information with the data packet set as a whole or the criterion for using the data packet set is used to indicate that at least the 1st data packet in the data packet set is needed to use the data packet set, a 1st data packet in the first data packet set fails.

Optionally, the criterion for using the data packet set is used to indicate at least one of the following:
the data packet set succeeds;
all the data packets in the data packet set succeed before the data packet set can be used;
the data packets whose proportion is greater than or equal to the first proportion in the data packet set succeed before the data packet set can be used;
data packets whose proportion is less than or equal to the third proportion in the data packet set fail before the data packet set can be used; and
at least the 1st data packet in the data packet set succeeds before the data packet set can be used;
or
the criterion for being incapable of using the data packet set is used to indicate at least one of the following:
the data packet set fails;
in a case that one or more data packets in the data packet set fail, the data packet set cannot be used;
in a case that data packets whose proportion is less than or equal to the first proportion in the data packet set succeed, the data packet set cannot be used;
in a case that data packets whose proportion is greater than or equal to the third proportion in the data packet set fail, the data packet set cannot be used; and
in a case that the 1st data packet in the data packet set fails, the data packet set cannot be used.

Optionally, the criterion for the data packet set to succeed is used to indicate at least one of the following:
in a case that a 1st data packet in the data packet set succeeds, determining that the data packet set succeeds;
in a case that data packets whose proportion is greater than or equal to a second proportion in the data packet set succeed, determining that the data packet set succeeds; and
in a case that all data packets in the data packet set succeed, determining that the data packet set succeeds.

Optionally, the criterion for the data packet set to fail is used to indicate at least one of the following:
in a case that one or more data packets in the data packet set fail, determining that the data packet set fails;
in a case that data packets whose proportion is greater than or equal to a third proportion in the data packet set fail, determining that the data packet set fails; and
in a case that at least a 1st data packet in the data packet set fails, determining that the data packet set fails.

Optionally, the criterion for discarding the data packet in the data packet set is used to indicate at least one of the following:
in a case that one or more data packets in the data packet set fail, the data packet in the data packet set is discarded or the data packet set cannot be used;
in a case that a 1st data packet in the data packet set fails, the data packet in the data packet set is discarded or the data packet set cannot be used; and
in a case that data packets whose proportion is greater than or equal to a fourth proportion in the data packet set fail, the data packet in the data packet set is discarded or the data packet set cannot be used.

According to this embodiment of this application, at least one of the first information and the first indication information is obtained, and based on at least one of the first information and the first indication information, it can be determined that the first data packet set succeeds or fails, or the data packet in the first data packet set is discarded, thereby avoiding transmission of unnecessary data packets, saving network resources, and effectively alleviating pressure on network resources.

The information handling apparatus provided in this embodiment of this application can implement the processes implemented in the method embodiment of FIG. 3, and achieve same technical effects. To avoid repetition, details are not described herein again.

The information handling apparatus provided in this embodiment of this application can implement the processes implemented in the method embodiment of FIG. 4, and achieve same technical effects. To avoid repetition, details are not described herein again.

Referring to FIG. 12, an embodiment of this application further provides an information handling apparatus 120, including:
a third operation module 121, configured to perform a third operation, where the third operation includes at least one of the following:
detecting second information of a first data packet set;
setting a packet header of a first data packet to include the second information of the first data packet set, where the first data packet is a data packet in the first data packet set; and
sending the first data packet set, where a packet header of the first data packet set includes the second information, and
the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set.

Optionally, the third communication device performing the third operation includes:
the third communication device receiving fourth information; and
the third communication device performing the third operation according to the fourth information, where
the fourth information includes at least one of the following:
protocol description information, where the protocol description information is used for at least one of the following: describing a protocol used for a service flow, and indicating that the protocol described by the protocol description information can provide information used to determine the second information of the first data packet set; and
second indication information or third indication information, where
the second indication information is used to indicate at least one of the following:
detecting second information of the data packet set; and
setting a packet header of a data packet to include the second information of the data packet set, where the data packet is a data packet in the data packet set, where
the third indication information is used to indicate at least one of the following:
detecting data packet set information corresponding to the data packet; and
setting the packet header of the data packet to include the data packet set information corresponding to the data packet.

Optionally, the handling information with the data packet set as a whole or the criterion for using the data packet set is used to indicate at least one of the following:
all data packets in the data packet set are needed to use the data packet set;
data packets whose proportion is greater than or equal to a first proportion in the data packet set are needed to use the data packet set; and
at least a 1st data packet in the data packet set is needed to use the data packet set.

Optionally, the criterion for using the data packet set is used to indicate at least one of the following:
the data packet set succeeds;
all the data packets in the data packet set succeed before the data packet set can be used;
the data packets whose proportion is greater than or equal to the first proportion in the data packet set succeed before the data packet set can be used;
data packets whose proportion is less than or equal to a third proportion in the data packet set fail before the data packet set can be used; and
at least the 1st data packet in the data packet set succeeds before the data packet set can be used;
or
the criterion for being incapable of using the data packet set is used to indicate at least one of the following:
the data packet set fails;
in a case that one or more data packets in the data packet set fail, the data packet set cannot be used;
in a case that data packets whose proportion is less than or equal to the first proportion in the data packet set succeed, the data packet set cannot be used;
in a case that data packets whose proportion is greater than or equal to a third proportion in the data packet set fail, the data packet set cannot be used; and
in a case that the 1st data packet in the data packet set fails, the data packet set cannot be used.

Optionally, the criterion for the data packet set to succeed is used to indicate at least one of the following:
in a case that the 1st data packet in the data packet set succeeds, determining that the data packet set succeeds;
in a case that data packets whose proportion is greater than or equal to a second proportion in the data packet set succeed, determining that the data packet set succeeds; and
in a case that all the data packets in the data packet set succeed, determining that the data packet set succeeds.

Optionally, the criterion for the data packet set to fail is used to indicate at least one of the following:
in a case that the one or more data packets in the data packet set fail, determining that the data packet set fails;
in a case that the data packets whose proportion is greater than or equal to the third proportion in the data packet set fail, determining that the data packet set fails; and
in a case that at least the 1st data packet in the data packet set fails, determining that the data packet set fails.

Optionally, the criterion for discarding the data packet in the data packet set is used to indicate at least one of the following:
in a case that the one or more data packets in the data packet set fail, the data packet in the data packet set is discarded or the data packet set cannot be used;
in a case that the 1st data packet in the data packet set fails, the data packet in the data packet set is discarded or the data packet set cannot be used; and
in a case that data packets whose proportion is greater than or equal to a fourth proportion in the data packet set fail, the data packet in the data packet set is discarded or the data packet set cannot be used.

According to this embodiment of this application, the first information of the first data packet set is detected; the packet header of the first data packet is set to include the first information of the first data packet set; or the first data packet set is sent, where the packet header of the first data packet set includes the first information, so that the first communication device or the second communication device can determine that the first data packet set succeeds or fails, or discard the data packet in the first data packet set, thereby avoiding transmission of unnecessary data packets, saving network resources, and effectively alleviating pressure on network resources.

The information handling apparatus provided in this embodiment of this application can implement the processes implemented in the method embodiment of FIG. 4, and achieve same technical effects. To avoid repetition, details are not described herein again.

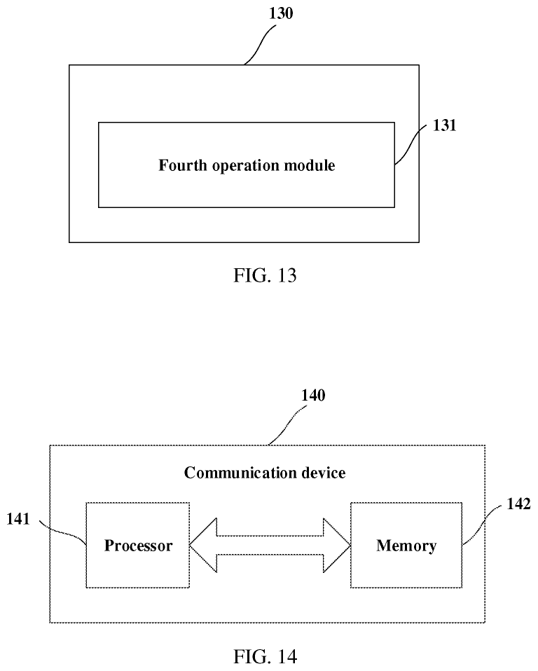

Referring to FIG. 13, an embodiment of this application further provides an information handling apparatus 130, including:
a fourth operation module 131, configured to perform a fourth operation, where the fourth operation includes at least one of the following:
sending at least one of first information and first indication information to a first communication device;
sending at least one of second information and the first indication information to a second communication device;
sending fourth information to a third communication device; and obtaining third information, where the third information is used to indicate one of the following information: inconsistent handling of all data packet sets with the data packet set as a whole, and consistent handling of all data packet sets with the data packet set as a whole, where
the first information or the second information is used to indicate at least one of the following:
handling information with the data packet set as a whole;
a criterion for using the data packet set, or a criterion for being incapable of using the data packet set;
a criterion for the data packet set to succeed, or a criterion for the data packet set to fail; and
a criterion for discarding a data packet in the data packet set, where
the first indication information is used to indicate at least one of the following: performing packet discarding according to the first information; discarding a data packet in a failed data packet set; and discarding the data packet in the data packet set, where
the fourth information includes at least one of the following:
protocol description information, where the protocol description information is used for at least one of the following: describing a protocol used for a service flow, and indicating that the protocol described by the protocol description information can provide information used to determine second information of a first data packet set; and
second indication information or third indication information, where
the second indication information is used to indicate at least one of the following:
detecting second information of the data packet set; and
setting a packet header of a data packet to include the second information of the data packet set, where the data packet is a data packet in the data packet set, where
the third indication information is used to indicate at least one of the following:
detecting data packet set information corresponding to the data packet; and
setting the packet header of the data packet to include the data packet set information corresponding to the data packet.

Optionally, the fourth operation module is configured to:
in a case that a ninth condition is met, send the first indication information to the first communication device, where
the ninth condition includes at least one of the following:
the first indication information is applicable to an uplink; and
handling of all data packet sets in a first object with the data packet set as a whole is inconsistent, where the first object includes at least one of the following: a data flow, a radio bearer, and a quality of service QoS flow.

Optionally, the fourth operation module is configured to:
in a case that a tenth condition is met, send the first information to the first communication device, where
the tenth condition includes at least one of the following:
the first information is applicable to an uplink;
the first indication information is applicable to the uplink; and
handling of all data packet sets in a first object with the data packet set as a whole is consistent, or first information of all the data packet sets in the first object is consistent, where the first object includes at least one of the following: a data flow, a radio bearer, and a quality of service QoS flow.

Optionally, the fourth operation module is configured to:
in a case that an eleventh condition is met, send at least one of the second information and the first indication information to the second communication device, where
the eleventh condition includes at least one of the following:
the second information is applicable to a downlink;
the first indication information is applicable to the downlink; and
handling of all data packet sets in a first object with the data packet set as a whole is consistent, or first information of all the data packet sets in the first object is consistent, where the first object includes at least one of the following: a data flow, a radio bearer, and a quality of service QoS flow.

Optionally, the fourth operation module is configured to:
obtain at least one of second information, third information, and first indication information; and
perform, by the fourth communication device, the fourth operation according to at least one of the second information, the third information, and the first indication information.

According to this embodiment of this application, at least one of the first information and the first indication information is sent to the first communication device or the second communication device, or the fourth communication device sends the second information to the third communication device, so that the third communication device detects the first information of the first data packet set based on the second information; and sets the packet header of the first data packet to include the first information of the first data packet set; or sends the first data packet set. Therefore, the first communication device or the second communication device can determine that the first data packet set succeeds or fails, or discard the data packet in the first data packet set, thereby avoiding transmission of unnecessary data packets, saving network resources, and effectively alleviating pressure on network resources.

The information handling apparatus provided in this embodiment of this application can implement the processes implemented in the method embodiment of FIG. 5, and achieve same technical effects. To avoid repetition, details are not described herein again.

As shown in FIG. 14, an embodiment of this application further provides a communication device 140, including a processor 141 and a memory 142. The memory 142 stores a program or instructions executable on the processor 141. For example, when the communication device 140 is a first communication device, the program or the instructions are executed by the processor 141 to implement the steps of embodiments of the information handling method performed by the first communication device, and can achieve same technical effects. When the communication device 140 is a second communication device, the program or the instructions are executed by the processor 141 to implement the steps of embodiments of the information handling method performed by the second communication device, and can achieve same technical effects. When the communication device 140 is a third communication device, the program or the instructions are executed by the processor 141 to implement the steps of embodiments of the information handling method performed by the third communication device, and can achieve same technical effects. When the communication device 140 is a fourth communication device, the program or the instructions are executed by the processor 141 to implement the steps of embodiments of the information handling method performed by the fourth communication device, and can achieve same technical effects. To avoid repetition, details are not described herein again.

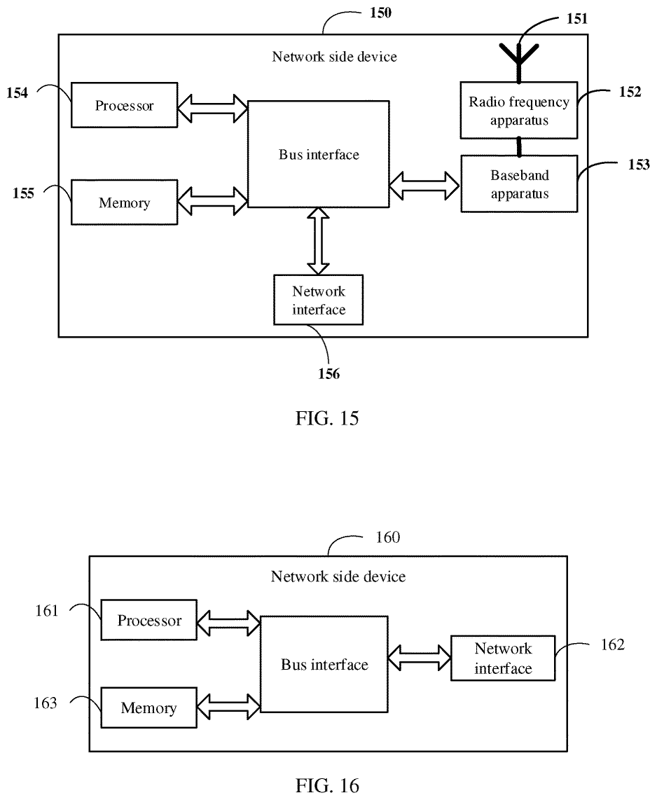

Specifically, an embodiment of this application further provides a network side device. As shown in FIG. 15, a network side device 150 includes an antenna 151, a radio frequency apparatus 152, a baseband apparatus 153, a processor 154, and a memory 155. The antenna 151 is connected to the radio frequency apparatus 152. In an uplink direction, the radio frequency apparatus 152 receives information by using the antenna 151, and sends the received information to the baseband apparatus 153 for handling. In a downlink direction, the baseband apparatus 153 processes to-be-sent information, and sends the handled information to the radio frequency apparatus 152. After handling the received information, the radio frequency apparatus 152 sends the handled information by using the antenna 151.

The method performed by a network side device in the foregoing embodiment may be implemented in the baseband apparatus 153. The baseband apparatus 153 includes a baseband processor.

For example, the baseband apparatus 153 may include at least one baseband board. A plurality of chips are disposed on the baseband board. As shown in FIG. 15, one of the chips is, for example, the baseband processor, and is connected to the memory 155 by using a bus interface, to invoke a program in the memory 155 to perform an operation of a network device shown in the foregoing method embodiment.

The network side device may further include a network interface 156, and the interface is, for example, a Common Public Radio Interface (CPRI).

Specifically, the network side device 150 in this embodiment of this application further includes instructions or a program stored in the memory 155 and executable on the processor 154. The processor 154 invokes the instructions or the program in the memory 155 to perform the method performed by the modules shown in FIG. 11, and same technical effects are achieved. To avoid repetition, details are not described herein again.

Specifically, an embodiment of this application further provides a network side device. As shown in FIG. 16, the network side device 160 includes a processor 161, a network interface 162, and a memory 163. The network interface 162 is, for example, a common public radio interface (CPRI).

Specifically, the network side device 160 in this embodiment of this application further includes instructions or a program stored in the memory 163 and executable on the processor 161. The processor 161 invokes the instructions or the program in the memory 163 to perform the method performed by the modules shown in FIG. 10 or FIG. 13, and same technical effects are achieved. To avoid repetition, details are not described herein again.

An embodiment of this application further provides a readable storage medium. The readable storage medium stores a program or instructions. The program or instructions are executed by a processor to implement the processes in the foregoing information handling method embodiment, and same technical effects can be achieved. To avoid repetition, details are not described herein again.

The processor is a processor in the terminal described in the foregoing embodiments. The readable storage medium includes a computer-readable storage medium, such as a Read-Only Memory (ROM), a Random Access Memory (RAM), a magnetic disk, or an optical disc. In some examples, the readable storage medium may be a non-transitory readable storage medium.

An embodiment of this application further provides a chip. The chip includes a processor and a communication interface. The communication interface is coupled to the processor. The processor is configured to run a program or instructions, to implement the processes in the foregoing information handling method embodiment, and same technical effects can be achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a storage medium. The computer program/program product is executed by at least one processor to implement the processes in the foregoing information handling method embodiment, and same technical effects can be achieved. To avoid repetition, details are not described herein again.

An embodiment of this application further provides a wireless communication system, including at least two of the following: a first communication device, a second communication device, a third communication device, and a fourth communication device. The first communication device may be configured to perform the steps of the method performed on the first communication device side, the second communication device may be configured to perform the steps of the method performed on the second communication device side, the third communication device may be configured to perform the steps of the method performed on the third communication device side, and the fourth communication device may be configured to perform the steps of the method performed on the fourth communication device side.

An embodiment of this application further provides a wireless communication system, including a first communication device and a second communication device. The first communication device may be configured to perform the steps of the method performed on the first communication device side, and the second communication device may be configured to perform the steps of the method performed on the second communication device side.

An embodiment of this application further provides a wireless communication system, including a first communication device and a fourth communication device. The first communication device may be configured to perform the steps of the method performed on the first communication device side, and the fourth communication device may be configured to perform the steps of the method performed on the fourth communication device side.

An embodiment of this application further provides a wireless communication system, including a second communication device and a third communication device. The second communication device may be configured to perform the steps of the method performed on the second communication device side, and the third communication device may be configured to perform the steps of the method performed on the third communication device side.

It should be noted that in this specification, the term “include”, “include”, or any of their variants is intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more limitations, an element preceded by “includes a . . . ” does not preclude the existence of additional identical elements in the process, method, article, or apparatus that includes the element. In addition, it should be noted that the scope of the methods and apparatuses in the implementations of this application is not limited to performing functions in a sequence shown or discussed, and may further include performing functions in a basically simultaneous manner or in a reverse sequence based on related functions. For example, the described methods may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for instructing a terminal or a network side device to perform the method described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from principles of this application and the protection scope of the claims, and all such implementations fall within the protection scope of this application.

1. An information handling method, comprising:
obtaining, by a first communication device, at least one of first information or first indication information; and
performing, by the first communication device, a first operation according to at least one of the first information or the first indication information, wherein the first information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; or
a criterion for discarding a data packet in the data packet set, wherein the first operation comprises at least one of the following:
determining that a first data packet set succeeds or fails;
discarding a data packet in the first data packet set; or
handling data with the data packet set as a whole, wherein
the first indication information is used to indicate at least one of the following: performing packet discarding according to the first information; discarding a data packet in a failed data packet set; or discarding the data packet in the data packet set.

2. The method according to claim 1, wherein the obtaining, by a first communication device, first information comprises:
receiving, by the first communication device, the first information sent by a second communication device or a fourth communication device;
or
obtaining, by the first communication device, the first information through local configuration or self-learning;
or
obtaining, by an access stratum AS of the first communication device, the first information via a higher layer of the first communication device.

3. The method according to claim 1, wherein the obtaining, by a first communication device, first indication information comprises:
receiving, by the first communication device, the first indication information sent by the second communication device or the fourth communication device;
or
obtaining, by the access stratum AS of the first communication device, the first indication information from a non-access stratum NAS or an application layer of the first communication device.

4. The method according to claim 1, wherein the discarding a data packet in the first data packet set comprises discarding at least one of the following: all data packets in the first data packet set, a remaining data packet in the first data packet set, a data packet in the first data packet set in a cache, an untransmitted data packet in the first data packet set, an unsuccessfully transmitted data packet in the first data packet set, a failed data packet in the first data packet set, a packet data convergence protocol service data unit PDCP SDU in the first data packet set, or a PDCP protocol data unit PDU in the first data packet set.

5. The method according to claim 1, wherein the discarding a data packet in the first data packet set comprises: discarding the data packet in the first data packet set in a case that a first condition is met, wherein
the first condition comprises at least one of the following:
the first information is obtained;
the first indication information is obtained;
that the first data packet set fails is determined;
the first data packet set does not meet at least one of the handling information with the data packet set as a whole, the criterion for the data packet set to succeed, or the criterion for using the data packet set; or
the first data packet set meets at least one of the criterion for the data packet set to fail, the criterion for being incapable of using the data packet set, or the criterion for discarding the data packet in the data packet set.

6. The method according to claim 1, wherein the determining that a first data packet set succeeds comprises:
in a case that a second condition is met, determining that the first data packet set succeeds, wherein
the second condition comprises at least one of the following:
the first data packet set meets at least one of the handling information with the data packet set as a whole, the criterion for the data packet set to succeed, or the criterion for using the data packet set.

7. The method according to claim 1, wherein the determining that a first data packet set fails comprises:
in a case that a third condition is met, determining that the first data packet set fails, wherein
the third condition comprises at least one of the following:
the first data packet set does not meet at least one of the handling information with the data packet set as a whole, the criterion for the data packet set to succeed, or the criterion for using the data packet set; or
the first data packet set meets at least one of the criterion for the data packet set to fail, the criterion for being incapable of using the data packet set, or the criterion for discarding the data packet in the data packet set.

8. The method according to claim 1, wherein the handling information with the data packet set as a whole or the criterion for using the data packet set is used to indicate at least one of the following:
all data packets in the data packet set are needed to use the data packet set;
data packets whose proportion is greater than or equal to a first proportion in the data packet set are needed to use the data packet set; or
at least a 1st data packet in the data packet set is needed to use the data packet set.

9. The method according to claim 6, wherein that the first data packet set meets the handling information with the data packet set as a whole is used to indicate at least one of the following:
in a case that the handling information with the data packet set as a whole or the criterion for using the data packet set is used to indicate that the data packets whose proportion is greater than or equal to the first proportion in the data packet set are needed to use the data packet set, a proportion of successful data packets in the first data packet set is greater than or equal to the first proportion, or a proportion of failed data packets in the first data packet set is less than or equal to a value obtained by subtracting the first proportion from 1; or
in a case that the handling information with the data packet set as a whole or the criterion for using the data packet set is used to indicate that at least the 1st data packet in the data packet set is needed to use the data packet set, a 1st data packet in the first data packet set succeeds, or the 1st data packet in the first data packet set does not fail;
or
that the first data packet set does not meet the handling information with the data packet set as a whole comprises at least one of the following:
in a case that the handling information with the data packet set as a whole or the criterion for using the data packet set is used to indicate that the data packets whose proportion is greater than or equal to the first proportion in the data packet set are needed to use the data packet set, a proportion of successful data packets in the first data packet set is less than or equal to the first proportion, or a proportion of failed data packets in the first data packet set is greater than or equal to a value obtained by subtracting the first proportion from 1; or
in a case that the handling information with the data packet set as a whole or the criterion for using the data packet set is used to indicate that at least the 1st data packet in the data packet set is needed to use the data packet set, a 1st data packet in the first data packet set fails.

10. The method according to claim 1, wherein the criterion for using the data packet set is used to indicate at least one of the following:
the data packet set succeeds;
all the data packets in the data packet set succeed before the data packet set can be used;
the data packets whose proportion is greater than or equal to the first proportion in the data packet set succeed before the data packet set can be used;
data packets whose proportion is less than or equal to a third proportion in the data packet set fail before the data packet set can be used; or
at least the 1st data packet in the data packet set succeeds before the data packet set can be used;
or
the criterion for being incapable of using the data packet set is used to indicate at least one of the following:
the data packet set fails;
in a case that one or more data packets in the data packet set fail, the data packet set cannot be used;
in a case that data packets whose proportion is less than or equal to the first proportion in the data packet set succeed, the data packet set cannot be used;
in a case that data packets whose proportion is greater than or equal to a third proportion in the data packet set fail, the data packet set cannot be used; or
in a case that the 1st data packet in the data packet set fails, the data packet set cannot be used.

11. The method according to claim 1, wherein the criterion for the data packet set to succeed is used to indicate at least one of the following:
in a case that a 1st data packet in the data packet set succeeds, determining that the data packet set succeeds;
in a case that data packets whose proportion is greater than or equal to a second proportion in the data packet set succeed, determining that the data packet set succeeds; or
in a case that all data packets in the data packet set succeed, determining that the data packet set succeeds.

12. The method according to claim 1, wherein the criterion for the data packet set to fail is used to indicate at least one of the following:
in a case that one or more data packets in the data packet set fail, determining that the data packet set fails;
in a case that data packets whose proportion is greater than or equal to a third proportion in the data packet set fail, determining that the data packet set fails; or
in a case that a 1st data packet in the data packet set fails, determining that the data packet set fails.

13. The method according to claim 1, wherein the criterion for discarding the data packet in the data packet set is used to indicate at least one of the following:
in a case that one or more data packets in the data packet set fail, the data packet in the data packet set is discarded or the data packet set cannot be used;
in a case that a 1st data packet in the data packet set fails, the data packet in the data packet set is discarded or the data packet set cannot be used; or
in a case that data packets whose proportion is greater than or equal to a fourth proportion in the data packet set fail, the data packet in the data packet set is discarded or the data packet set cannot be used.

14. The method according to claim 1, wherein the failed data packet comprises at least one of the following: a data packet that fails to be sent; a data packet that fails to be received; a data packet that fails to be transmitted; a data packet for which no receiving acknowledgment is received after the data packet is sent; one of the following present in a case that a Discard timer expires: the data packet, and a PDCP SDU or a PDCP PDU corresponding to the data packet; or a PDCP SDU or a PSCP PDU in a case that the Discard timer expires;
or
that the data packet fails comprises at least one of the following:
the data packet fails to be sent;
the data packet fails to be received;
the data packet fails to be transmitted;
no receiving acknowledgment is received after the data packet is sent; or
the data packet fails when the data packet or the PDCP SDU or the PDCP PDU corresponding to the data packet is present in a case that the Discard timer expires.

15. The method according to claim 1, wherein before the performing, by the first communication device, a first operation according to at least one of the first information or the first indication information, the method further comprises:
sending third information to the second communication device or the fourth communication device, wherein the third information is used to indicate one of the following: inconsistent handling of all data packet sets with the data packet set as a whole, and consistent handling of all data packet sets with the data packet set as a whole.

16. An information handling method, comprising:
obtaining, by a second communication device, at least one of second information, third information, or first indication information; and
performing, by the second communication device, a second operation according to at least one of the second information, the third information, or the first indication information, wherein
the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; or
a criterion for discarding a data packet in the data packet set, wherein
the second operation comprises at least one of the following:
determining that a first data packet set succeeds or fails;
discarding a data packet in the first data packet set;
sending at least one of first information or the first indication information to a first communication device; or
handling data with the data packet set as a whole, wherein
the first information is used to indicate at least one of the following:
the handling information with the data packet set as a whole;
the criterion for using the data packet set, or the criterion for being incapable of using the data packet set;
the criterion for the data packet set to succeed, or the criterion for the data packet set to fail; or
the criterion for discarding the data packet in the data packet set, wherein
the first indication information is used to indicate at least one of the following: performing packet discarding according to the first information; discarding a data packet in a failed data packet set; or discarding the data packet in the data packet set; and
the third information is used to indicate one of the following information: inconsistent handling of all data packet sets with the data packet set as a whole, and consistent handling of all data packet sets with the data packet set as a whole.

17. An information handling method, comprising:
performing, by a third communication device, a third operation, wherein the third operation comprises at least one of the following:
detecting second information of a first data packet set;
setting a packet header of a first data packet to comprise the second information of the first data packet set, wherein the first data packet is a data packet in the first data packet set; or
sending the first data packet set, wherein a packet header of the first data packet set comprises the second information, and
the second information is used to indicate at least one of the following:
handling information with a data packet set as a whole;
a criterion for using the data packet set, or a criterion for being incapable of using the data packet set;
a criterion for the data packet set to succeed, or a criterion for the data packet set to fail; or
a criterion for discarding a data packet in the data packet set.

18. A communication device, comprising a processor and a memory, wherein the memory stores a program or instructions executable on the processor, and when the program or instructions are executed by the processor, the steps of the information handling method according to claim 1 are implemented.

19. A communication device, comprising a processor and a memory, wherein the memory stores a program or instructions executable on the processor, and when the program or instructions are executed by the processor, the steps of the information handling method according to claim 16 are implemented.

20. A communication device, comprising a processor and a memory, wherein the memory stores a program or instructions executable on the processor, and when the program or instructions are executed by the processor, the steps of the information handling method according to claim 17 are implemented.
